(19) United States
(12) Patent Application Publication
(10) Pub. No.: US 2015/0049919 A1
(43) Pub. Date: Feb. 19, 2015

(54) apparatus for diagnosis and control of honeybee varroatosis, image processing method and software for recognition of parasite

(71) Applicant: Priit Humal, Tartu (EE)

(72) Inventor: Priit Humal, Tartu (EE)

(21) Appl. No.: 14/387,237

(22) PCT Filed: Mar. 27, 2013
(86) PCT No.: PCT/EE2013/000004

§ 371 Date: Sep. 23, 2014

(30) Foreign Application Priority Data
Mar. 27, 2013 (EE) P201200005

(51) Int. Cl. A01K 51/00; A01M 1/20; G06T 7/00; A01M 13/00

(52) U.S. Cl. CPC A01K 51/00; A01M 13/00; A01M 1/2027; G06T 7/0012
USPC 382/110

(57) ABSTRACT

An device for diagnosis and control of honeybee varroatosis (Varroa mite infection) comprises one or several cameras (310), connected to image processor (311). The software of the device is capable of processing the picture of honeybee, recognition the presence or absence of varroa mite on the body of the bee on the field-of-view of the cameras or in the chamber for observation, counting the infected and non-infected bees, separating the infected bees from non-infected bees or killing the recognized varroa mites. Controlled gates (314, 315, 316), valves, positioning actuators and/or heaters (329, 330) are used as output devices for realization of the said actions. The method of image processing for recognition of varroa mite or other parasites comprises of searching reflections in the image and analysis of the surroundings of the found reflections. Also the method for determination of location of body elements of insect in an image is disclosed.

### TECHNICAL FIELD OF THE INVENTION

This invention belongs to the field of veterinary, more specifically to bee infections and parasite control devices and methods.

### BACKGROUND OF THE INVENTION

Bees in most parts of the world are threatened by the Varroa destructor and Varroa jacobsin mite. The varroa mite is a harmful parasite, which is capable of destroying entire bee colonies in the course of a few years. Varroa mites weaken bees, deform their bodies and increase the chances of infection from other diseases. The European bee (Apis mellifera) has no natural protection against the varroa mite and is in danger in every stage of its life.

Bee varroatosis control methods include known chemical, mechanical and thermal treatment methods. In these methods, the mite is distinguished from bees due to its smaller size and mass, thanks to which it is more sensitive than bees against short-term exposure to chemicals and heat. Separated mites easily fall through small openings, through which bees cannot fit.

Harry E. Vanderpool (U.S. Pat. No. 6,702,645 Separating parasites from bees) suggests a device where bees and mites are exposed to a substance, which forces the mites to separate from the bees and separated in this way mites are directed, by an air stream, through a sieve. As an example of such a substance is used sugar powder. Unfortunately, the number of mites extracted from bees, using this method, in relation to those left with mites, is not very high.

A more effective way of parasites control could be using of a live video with image processing and means to kill each detected parasite. This idea has been used to kill fish parasites by Esben Beck (WO 2011115496 A1, Method and device for destroying parasites on fish), where parasites detected on live video frames are killed using high intensity pulses of light, which are automatically positioned to the detected parasite location.

As an alternative to selective destroying of parasites, damaged objects, for example fish fillet, can be detected and removed, if image processor finds a parasite (Takashi Okamoto US2007/0238147A1, JP 2007-286041 Method of detecting foreign matter, Ernest M. Reimer U.S. Pat. No. 6,061,086 Apparatus and method for automated visual inspection of objects).

Counting of mite infected bees on a video image is described in, Jasna Kralj. Parasite-host interactions between Varroa destructor Anderson and Trueman and Apis mellifera L. Influence of parasitism on flight behavior and on the loss of infested. Frankfurt am Main: Fachbereich Biologie and Informatik der Johann Wolfgang Goethe—Universität, 2004. Video-cameras are placed under and above the transparent pipes that connect the landing board to the hive entrance. The recordings were later examined, in order to count the number of varroa mite infected bees. This was very time consuming, as people had to examine all the recorded material. Also, due to the straight position, with the wings close to the body, that the bees must maintain, when passing through the pipes into the hive, it is not possible to achieve high detection rate of the mites on the back of the bee even by human operator.

Counting of bees by use of a camera above the landing board is described in the work of J. Campbell, L. Mummert and R. Sukthankar. Video Monitoring of Honey Bee Colonies at the Hive Entrance. ICPR Workshop on Visual Observation and Analysis of Animal and Insect Behavior, December 2008. The goal was to collect statistics of the bees flying in and out of the hive, and have not paid attention to the detection of varroa mites. There are many methods for detecting objects, including insects. The closest to this invention are:
Ernest M. Reimer U.S. Pat. No. 6,061,086 Apparatus and method for automated visual inspection of objects.
Val R. Landwehr U.S. Pat. No. 7,496,228 Method and system for detecting and classifying objects in images, such as insects and other arthropods.
Henry J. I. Baxdell GB 2480496A Method and apparatus for the monitoring and control of pests in honeybee colonies.

In the described methods for insect detection, based on boundaries and histograms, it is assumed that it is possible to get a picture of the entire insect. Parasites, such as the varroa mite, can, however, be hidden between the host's body parts and, therefore, only a part of the parasite may be on a given image.

Common varroatosis control solutions are, in principle, unselective and utilize chemical and/or physical effects, which affect both the mites as well as the bees. The problem with the solutions is the similarity between the mite and bee organisms, due to which, the dosage interval that works against mites and does not affect the bee is quite narrow.

Common computer vision detection methods try to find parasites within the entire observed area, not taking into account the link between the parasite and host. Also, computer vision detection methods have not used specialized chambers.

### SUMMARY OF THE INVENTION

To solve the described problems, this invention proposes two alternative devices to diagnose or control varroatosis, as well as the necessary method and software for parasite detection.

The first alternative device comprises one or more cameras, which are connected to one or more image processors with specific software. The one or more processors function is to recognize image of the bee from raw image and by applying image processing to said bee image and/or by displaying bee images taken with different orientation in relation to the bee to operator for assist by his decision, to determine the presence or absence of varroa mite on the body of one or more bees. Based on that, the device will do one or more action of the following list:

a) count the number of infected and non-infected bees,

b) separate infected bees from the non-infected bees,

c) kill the detected mite.

In order to carry out action b) or c), the device is equipped with actuators, which are connected to said processors. The actuators may be, for example, controllable gates, controllable air pumps and valves, positioning devices or a controllable heat source.

The cameras are positioned above the landing board and/or below the transparent landing board.

Above the landing board there are one or more nozzles, into which infected bees can be sucked by air stream. In order to create the airstream, an electromagnet impulse pump can be fit. The said nozzles are placed on moveable carriage, equipped with a positioning drive. On the carriage there may be a heat element, for example, a semiconductor laser, complete with the necessary optics, which kills the detected mites on the bees, leaving the bees untouched undamaged.

The device may contain comprise a further light source that could be controlled by the said image processor and should be capable of creating light impulses. Light impulses length is preferably in range from 0.1 microsecond to 0.2 seconds to expose the bee.

Under natural light, it is possible for the-said device to work without the extra (artificial) light source. The sun, in this case, shall be considered as light source creating reflections.

The alternative solution for diagnosing and controlling varroatosis in bees is disclosed a device which has comprises at least one observation chamber, at least one light source and at least one camera, which is connected to at least one image processor, with varroa mite detecting software. The said processor may also control actuators to govern the bees' movement to and from the observation chamber. The actuators may be, e.g.:

a) controllable gates, which enable the processor to inhibit or allow entrance of bees into the observation chamber or exit from there,

b) light sources to attract bees,

c) valves or pumps, to control the flow of air or narcotic gases into and out of the observation chamber.

Preferably the said light sources are controlled by the image processor. In addition to the normal on-off switching function, preferably at least one light source has impulse mode to generate light impulses which are synchronized with the frame frequency of the camera. Light impulses length is preferably in range from 1 microsecond to 0.2 seconds.

The said observation chambers are preferably large enough to allow the bee to turn around and/or spread its wings further away from its body.

Several cameras and/or mirrors may be positioned in the device in such a way as to be able to acquire images of the bee or bees under observation from at least 3 different observation points, preferably at view angles that differ from each other approximately by quotient of 360 degrees divided by the number of view directions.

The software of image processor(s) is able to detect a varroa mite on raw images, acquired from observation chambers, and, based on that is capable to:

a) count the number of infected and non-infected bees,

b) separate infected bees from non-infected other bees,

c) kill the detected mite.

In order to carry out b) and/or c), the device is supplied with actuators that are connected to the afore-mentioned one or more image processors. The actuators may be controllable gates, air or narcotic gas pumps and valves, positioning device or controllable heat source. The image processor can control the gates to inhibit or allow bees to enter or leave the observation chamber.

The image processor for both alternative devices comprises the image processing software that comprises a module with the function to detect mites in one or more pictures acquired of the same bee using the following algorithm:
A) The image is searched for pixels corresponding to the characteristics of a varroa mite that may be one or several adjacent pixels, which have a similar color to the reflection of light source from the glossy body of the mite or similar color to the mite color.
B) One or more surrounding regions of various sizes are assigned to the said pixels.
C) Color values of pixels in each assigned surrounding regions are analyzed preferably to the similarity to the color value common for a mite, and according to presence of the pixels having typical color values each region is assigned a region rating, indicating the probability that there is a varroa mite in the current region.
D) From the ratings of different regions in the image and also based on the analysis of different images of the same bee, it is determined, whether the given bee is or is not infected by a varroa mite.

The analysis of pixels, in order to determine the relation between the color of the given pixel and the characteristic color of a varroa mite, the analysis of pixels may be carried out in suitable ranges of the HSB color space or three-dimensional tables in the RGB color space, where for each color there is a rating indicating its similarity to the color of mites. The pixels of some colors may be found on both bees as well as mites. For such colors, it is suggested to assign lower ratings. For colors that are rare in bees, but are in mites, should have a higher rating.

The software also includes comprises a module, whose function is to determine the location of a bee's body zones on multiple images and a module, whose functions is to compose a combined rating according to detection ratings from same body areas from different raw images or count presence of different body parts in the images and to determine, based on combined rating or counting results the presence or absence of a mite.

In addition, the current invention provides the image processing software has a module, whose function is to determine the location of a bee's body zones in an image, and a module, whose function is to adjust the criterias for detecting a varroa mite, depending on the mite detecting body zone of the bee or exclude of the presence of a varroa mite in areas where the false positive detection according the algorithm is highly possible.

The bee image processing software has comprises a further module with the function to adjust various image processing parameter values, using images of bee or mite, where mite detection has been successfully performed by the image processing or with the help of an operator. The parameters can be limits of color range required when searching pixels having similar color values to reflection of light source from glossy body of the mite, rating limits for pixels in the surrounding region or the minimal pixel rating required for region rating in the surrounding region for mite presence determination.

In the second alternative of the device there are one or more observation chambers in the field-of-view of the cameras, supplied with controllable gates, through which bees can enter and exit the chambers. Preferably the said observation chambers are large enough to allow bees to move or turn around and/or allow their wings to be spread away from their abdomen. In addition, the device may comprise light sources, which are controlled by the processor, to provoke bees into moving in a certain way.

Both alternative devices have a step or other means in the field-of-view of the cameras, on which a bee, when climbing, moves its body in such a way as to allow for a better view of a mite in the gap between the thorax and abdomen. Both alternative devices have also actuator, controlled by image processor, in form of heating element that can be made as a source of collimated radiation in a way, that its radiation can be directed by the image processor to the position of the mite.

In addition to separating infected bees from the non-infected, this invention provides the possibility to detect and kill a mite that has separated from bees. For that, the device has an impulse light source, such as a gas discharge lamp, laser or light emitting diode. In order to transport bees to and from the observation chambers or observation areas, the invention opens the use valve-controlled air streams.

After the image processing have determined the location of the parts of a bee body on an image, this invention provides to count the number of times a specific body part has been presented and to continue processing of raw images of the bee, until the mite detection has been processed at enough different orientations to ensure a negative result, or to have reassurance based on different images from the same body zone in the case of a positive result. If multiple detections exist in the same body zone with a probability rating of over 50%, some statistical process is carried out, to calculate the combined rating, for example multiplying the contra-probabilities of detection obtained by different detections.

In addition to disclosed above devices, this invention provides a method of detecting parasites that may be used as for detecting varroa mites, so in various other fields, which require such image processing capabilities, the devices of which may differ from the ones described herein.

The method for parasite detection using image processing techniques on an image of the host goes through comprises the following steps:

A) The image of the host is searched for pixels whose color corresponds to the characteristic for the reflected light of the light source. This may be one or several adjacent pixels, which have a similar color values to the reflection of light from the glossy body of the parasite.

B) The said pixels are assigned o One or more surrounding regions of various sizes are assigned to the said pixels.

C) Color values of pixels in each assigned surrounding regions are analyzed to the similarity to the color value, common for a mite, and each surrounding region is assigned a region rating, indicating the probability that there is a parasite in the determined area of the body of host.

D) Based on surrounding region ratings it is determined, whether the host is or is not infected by a parasite.

With the implementation of this method several images of the host are acquired. Combined rating based on detection rates of several images yields more correct result than rating from a single image. As the host moves itself between the expositions, it is possible to watch the parasite and host on the images from different directions. When combining detection rating it is rational to determine location of different zones of host on different images and to use for combined rating region ratings for the same body zones from the different images.

The next subject of the current invention is a method for determination of location of body elements in an image of an insect comprising the following steps:

A) separating the image of the insect image background and thresholding the said image to binary image;

B) eroding the insect blob by number of pixels enough to remove legs;

C) dilating result of eroding by about the same number of pixels or preferably by slightly higher amount of pixels;

D) subtracting result of dilation from initial binary image; whereas the result of dilation obtained in point C) is considered as body core and result of subtraction in point D) is considered as legs. From determined legs antennas are selected as legs whose quotient of area to border length is less than certain criteria (e.g. 7). Head of the insect is considered to be in this side of body where antennas are determined or which is closer to center of gravity of all legs.

For application of the devices and methods corresponding to the current invention, the afore described software (computer programme product) stored in the memory of a processor of device, including software code portions, is provided. The software is adapted to perform the aforesaid methods, when the computer program is running in the image processor.

### BRIEF DESCRIPTION OF THE DRAWINGS

FIG. 1 presents the device according to the first embodiment.

FIG. 2 presents the device according to the second embodiment, attached to the walls of the hive.

FIG. 3 presents the device according to the second embodiment, with the main parts separated.

FIG. 4 presents the device according to the fourth embodiment.

FIG. 5 presents the device according to the fifth embodiment.

FIG. 7-FIG. 12 present the mite detection procedure flow chart.

FIGS. 13 and 14 present the data arrays that are used by detection of the mite.

FIGS. 15 and 16 presents the co-ordinate system for dividing the body of a bee into the zones.

FIG. 17 and FIG. 18 present a back view image of a bee and patterns generated to determine the bee's posture.

FIG. 19 and FIG. 20 present a side view image of a bee and patterns generated to determine the bee's posture.

FIG. 21 and FIG. 22 present an underside view image of a bee and patterns generated to determine the bee's posture.

FIG. 23 and FIG. 24 present a bee's body being divided into zones.

FIG. 25 presents a bee infected by two mites.

FIG. 26 presents reflections detected on a bee.

FIG. 27 presents the hue parameters for the reflection detection method.

FIG. 28 presents color signatures detected on a bee.

FIG. 29 presents pixels with characteristic color value rated for color signatures method.

FIG. 30-FIG. 32 present an image of a varroa mite on a bee in the HSB color space (FIG. 30—H, FIG. 31—S, FIG. 32—B).

### PREFERRED EMBODIMENTS

### Example 1

### The First Embodiment of the Device

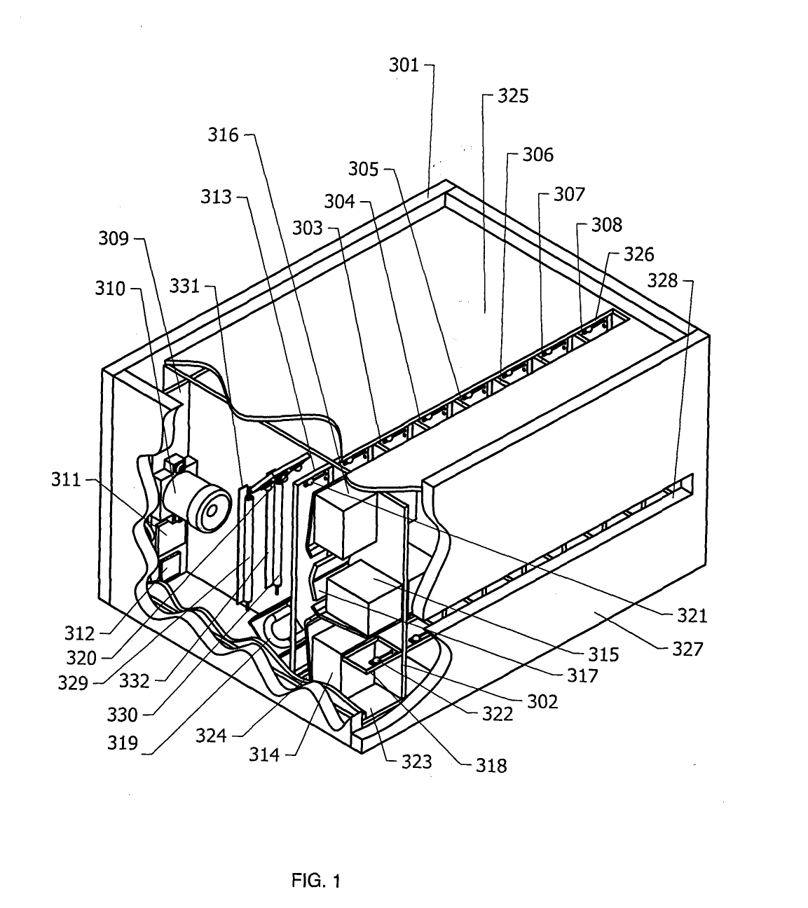

The device (FIG. 1) has the body 301, which contains eight identical sections, separated by dividing sheets 302, 303, 304, 305, 306, 307 and 308. We continue by describing the foremost section, shown in the figure through the cut partition. The section comprises the camera 310, which is placed on the printed circuit board 309, the image processor 311 with its memory 312, the glass window 313, electromagnet gates 314, 315 and 316, barrier 317 and transparent barrier 318, gas discharge lamp 319 and LED lamps 320 as well as attraction lights 321 and 322. The LED lamps 320 work in the red spectra, which is invisible to bees. The barrier 317 is v-shaped, creating a step, over which bees must climb and bend their bodies in such a way as to allow for better visibility of the gap between their thorax and abdomen and possible mite in the gap. The electromagnet gates 314, 315 and 316, and the light sources 319 and 320 are connected to the processor 311, via the required power elements. The base 323 have an entrance slot 324, top 325 have an exit slot 326 and one side 327 have another exit slot 328. Between the camera 310 and glass window 313 are gas discharge lamps 329 and 330, which are equipped with reflectors 331 and 332 and are placed outside of the field-of-view of the camera 310. The said lamps are controlled by the image processor 331. The glass window 313, barrier 318 and electromagnet gates 314, 315 and 316 form an observation chamber, which is observed by the camera 310.

The device is placed on a bee reservoir in such a way that bees can enter the device through the entrance slot 324. A reservoir for non-infected bees is placed on top of the device at exit slot 326 and a reservoir for infected bees is placed at exit slot 328.

The said reservoirs are equipped with retaining valves and attracting lights to prevent bees from congregating around the electromagnet gates 315 and 316.

All eight sections work independently of each other. The following describes the working of the device using the example from the open section in FIG. 1.

The attracting lights 321 and 322 are periodically switched on and off. When the lights are switched off, the bees move following the scent of the bees that previously passed there. In order to acquire images of good quality, the area under observation of camera 310 is illuminated by the gas discharge lamp 319 or LEDs 320, which are controlled by the processor 311 to generate short, high-intensity light impulses. The red light, which is invisible to bees, is used when a bee is being let into or out of the observation chamber, where one of the electromagnet gates 314, 315 or 316 is open. When determining the position of a bee's body parts and presence of a varroa mite, color images are used, exposed by the gas discharge lamps. Each image, by exposition of the each light source, is processed by the image processor 311.

While there is no bee in view of the camera 310, the processor holds the gate 314 open. Gates 315 and 316 are closed. When a bee enters from the slot 324 and reaches into the observation chamber, through open gate 314 and to field-of-view of the camera 310, it is determined by the presence of a motion detection in the image frames from the camera. Once a bee passes through gate 314, the processor 311 closes it. While all gates, 314, 315 and 316 are closed, the bee moves within the confines of the glass window 313 and barrier 317, seeking for escape. It is then, that the procedure for mite detection, as described in the next paragraph, is run. Once the procedure is finished, one of the exit gates is opened, depending on the result: 315 if the bee is infected or 316 if the bee is not infected. LED lights are used to acquire monochromatic image of the bee until it is detected that the bee has left the chamber via an opened gate. If a separated mite has been detected during varroa mite detection procedure, the gate 315 is opened, and after the bee has left, the gas discharge lamps 329 and 330 are activated, to kill the mite with the heat. When the observation chamber is empty, gate 314 is opened and the procedure begins again with next bee.

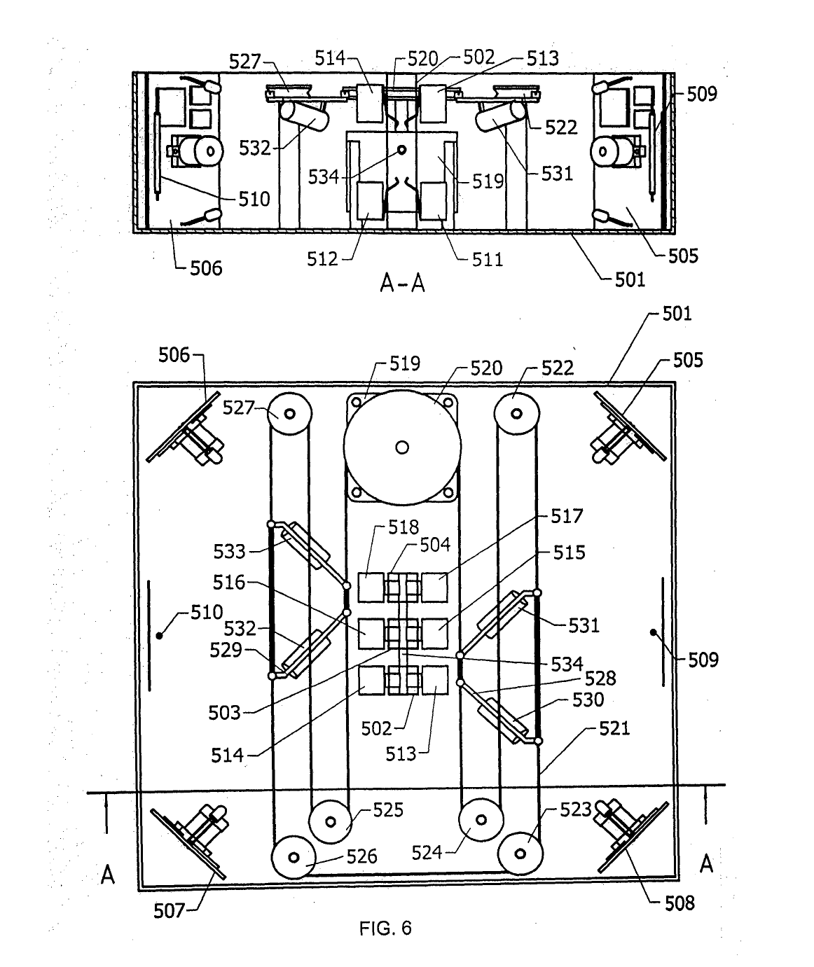

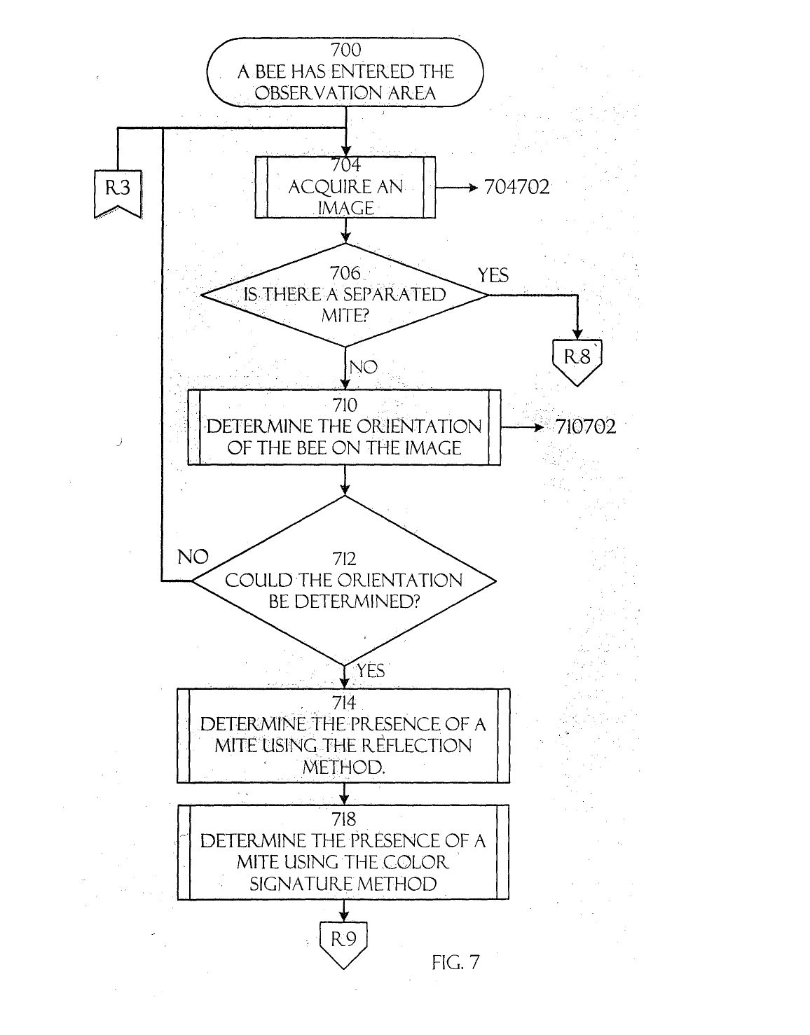

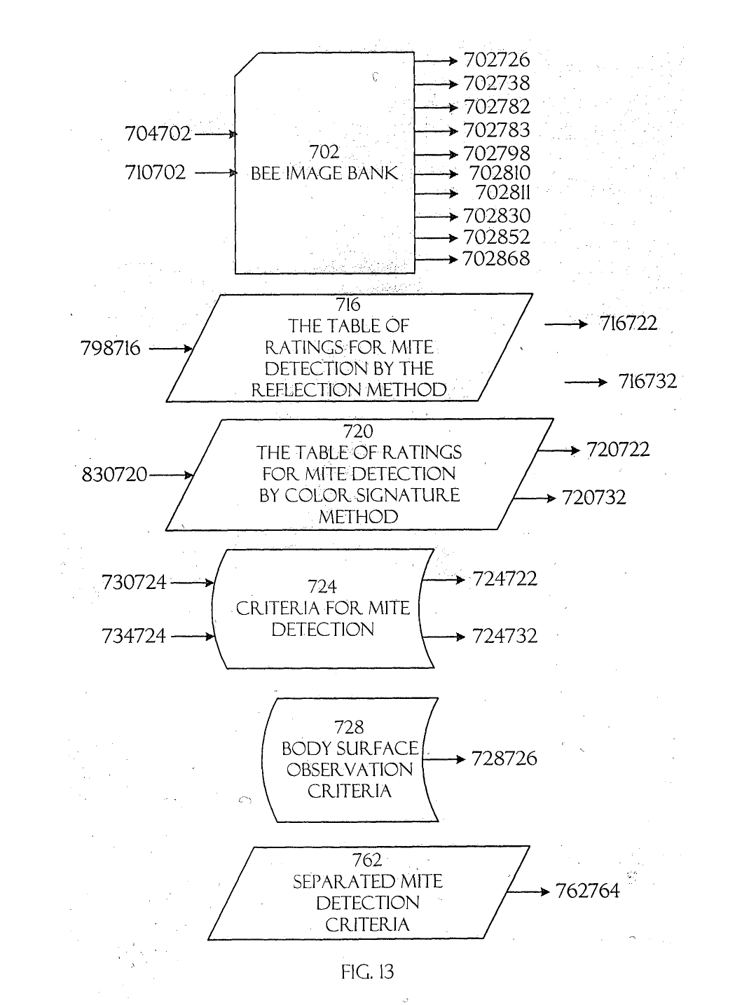

The detection of varroa mite by image processing is carried out according to the diagrams shown in FIG. 7-FIG. 14, where FIG. 7-FIG. 12 are flowcharts of the procedures, FIG. 13 and FIG. 14 are tables and data structures used in these procedures.

The relationships between the procedure blocks and data blocks are shown be the six figure numbers near each block, where the first three digits indicate the source block and the last three digits indicate the destination block. The run of the procedure between the figures is indicated by off page reference arrows R1 to R9. The procedure begins with the step “ACQUIRE IMAGE” (block 704, FIG. 7), which comprises of steps 750 till 756, on FIG. 9. It acquires the image, exposed by the gas discharge lamps, from which has been removed the background, using an image acquired without a bee as a reference. The resolution of the image is ca 40 pixels per mm. Thus, the length of the bee is ca 600 pixels and the diameter of a varroa mite ca 60 pixels. The image (704702) is saved in the image bank (FIG. 13), and the sizes of the objects detected are determined (block 706, FIG. 7). Objects of relative small size may be mites separated from the bees, the detection of which takes place in section R8 (FIG. 9).

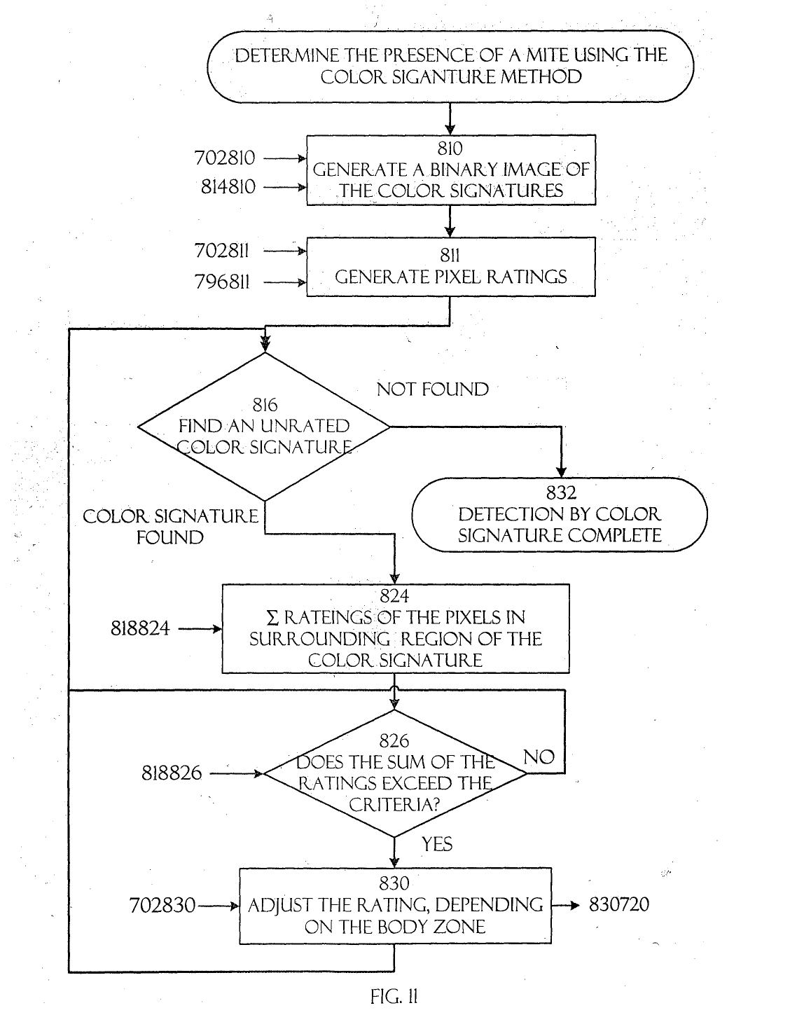

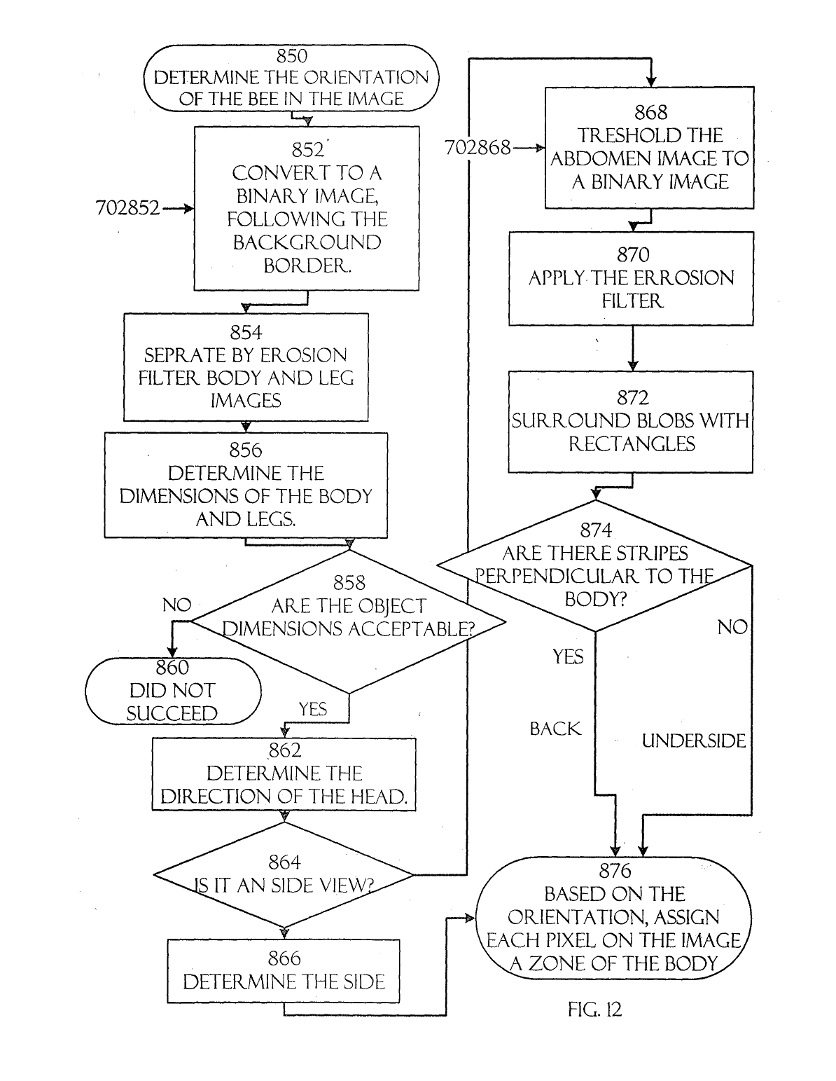

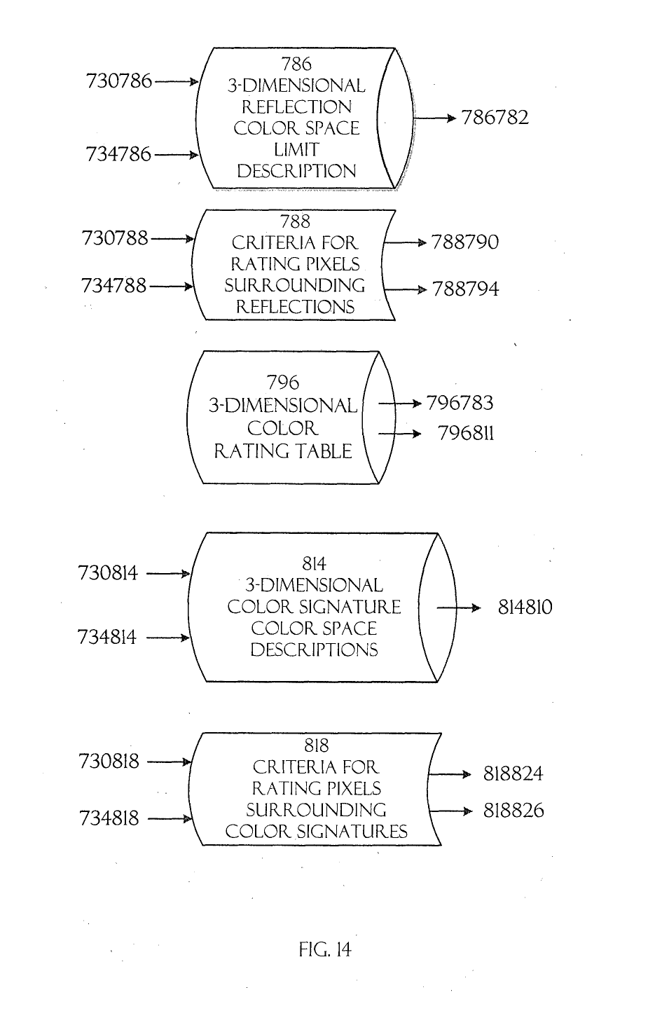

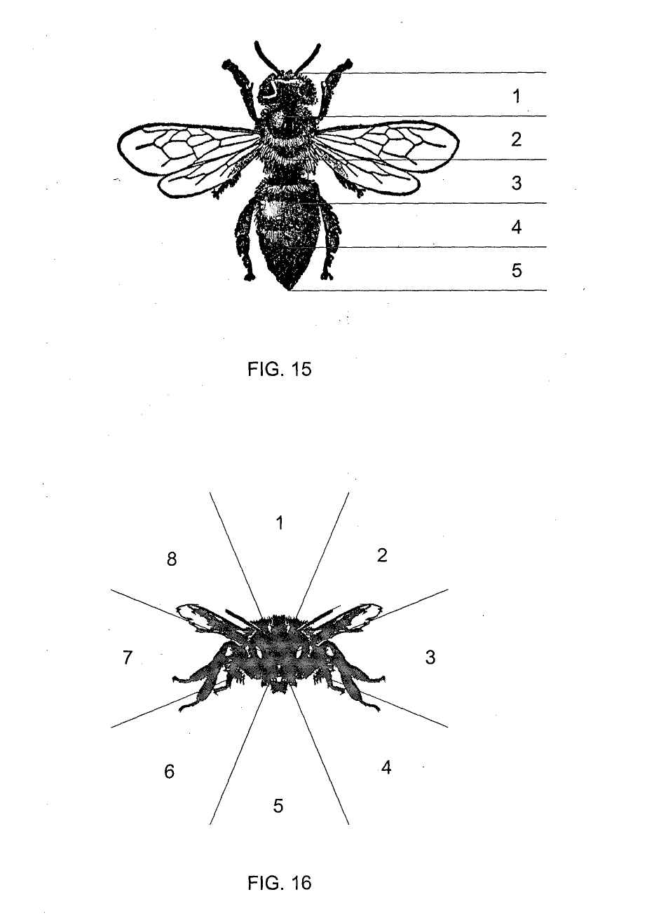

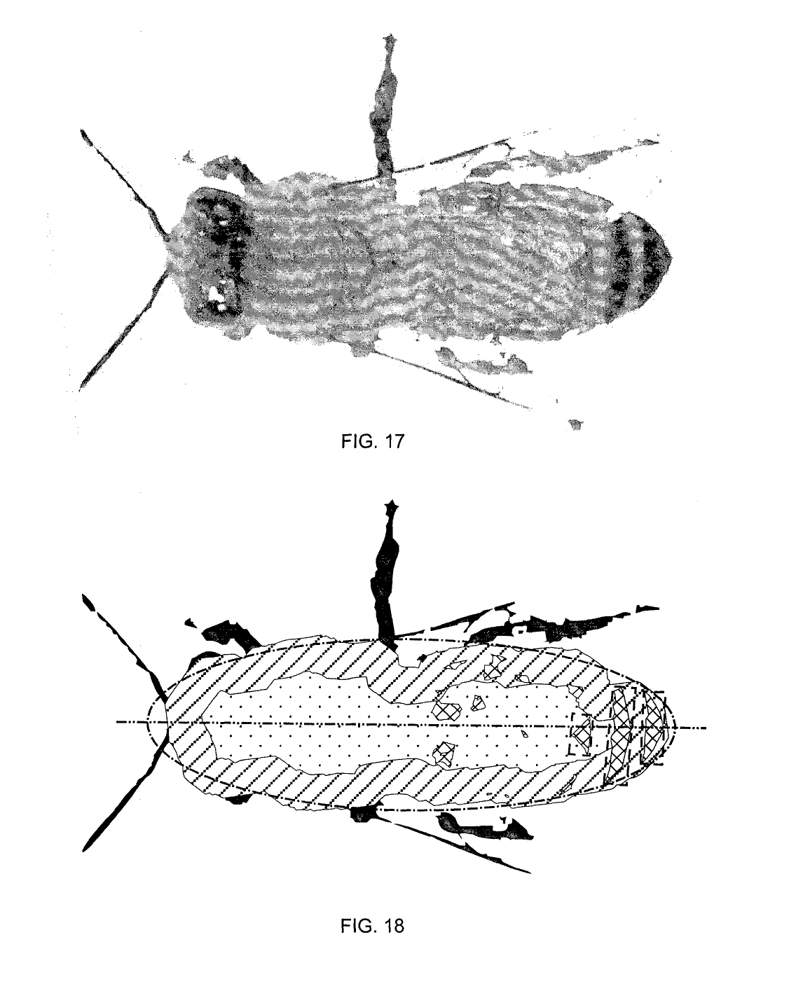

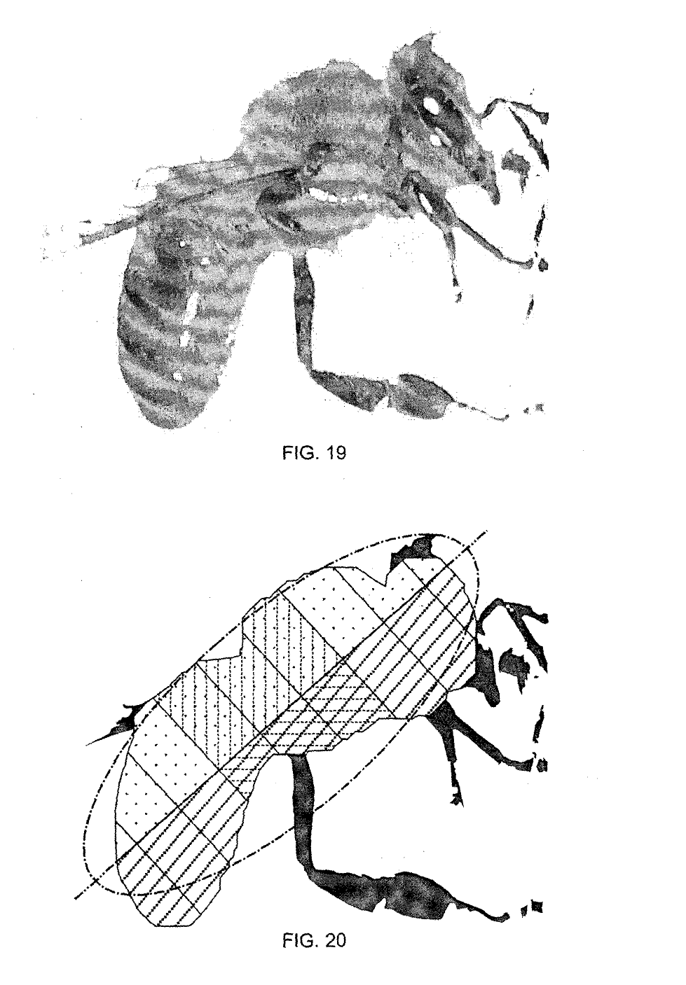

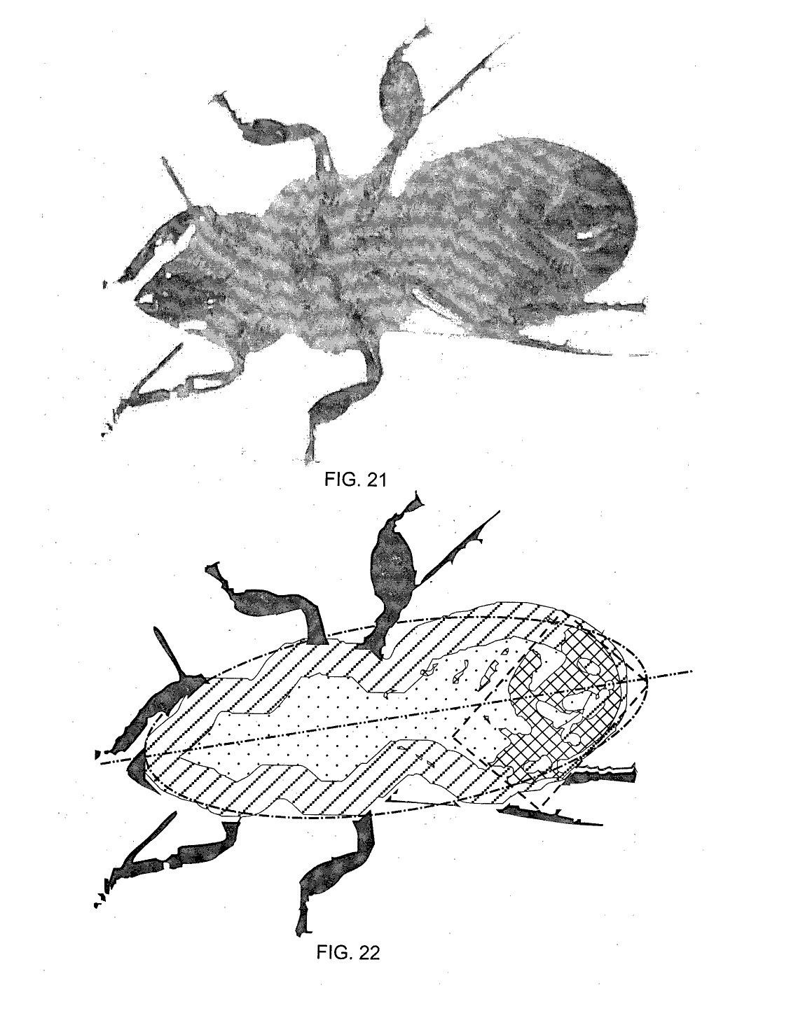

A larger objects must be a bee and next the orientation of the bee's body and location of its parts (FIG. 15 and FIG. 16) in the image is determined in block 710 (FIG. 7), where the procedure shown on FIG. 12 is used. The patterns used in the determination of the orientation are shown in FIG. 18, FIG. 20 and FIG. 22, which are obtained from images on FIG. 17, FIG. 19 and FIG. 21 respectively. In block 852 (FIG. 12), the digital image is converted into a binary image, where each ‘1’ represents the object foreground and ‘0’ represents the background (the whole picture, separated from the background, is presented on FIG. 17 till FIG. 22). In block 854, the said binary image is eroded by 40 pixels, resulting in the removal of all protruding body parts (legs, antennas, wings). The obtained image is the middle section of the main body of the bee (dotted area in FIG. 18, FIG. 20, FIG. 22). Now the image is dilated by 44 pixels (hatched are in FIG. 18, FIG. 20, FIG. 22), resulting an body blob almost as large as in the initial image, without the protruding body parts. Subtracting obtained body blob from the initial binary image, we get the legs blobs separated from body (black area on FIG. 18, FIG. 20 and FIG. 22). All the removed objects whose area (area in this case and later on in this document, is considered as the number of pixels forming the given object) is below the given limit (100 pixels) are discarded while for the remaining their lengths and co-ordinates of the mass centre are determined. The border of the body segment is approximated with ellipse in block 856 (FIG. 12) by the method of least squares (dash dotted line in FIG. 18, FIG. 20, FIG. 22). The vertices of the ellipse are considered to be the extremities of the body and the distance between the two (the major axis of the ellipse) is considered the length of the body. If the calculated length matches the given criterion (>300 pixels), it is decided in block 858, that it should be possible to determine the orientation of the bee in the image. If the length does not match the criterion, the orientation determination function is relinquished (in block 860) and the procedure in block 712 (FIG. 7) returns to block 704, for acquiring a new image.

If it is decided, in block 858 (FIG. 12), that it might be possible to determine the orientation, the location of the head is determined, in block 862. In order to find the head, the procedure attempts to find the antennas, which are detected as a limb, whose center's projection to the extension of body axis (for which is used the focal axis of the ellipse) is outside of the extremities of the body, whose quotient of area to contour length is less than 7 and the area is larger than 100 pixels. If at least one antenna is found, the nearest to it extremity of body is considered to be the head. If antennas could not be detected, the procedure calculates the arithmetic mean of the center co-ordinates of all stand-alone objects and the head is considered to be the extremity that is closer to the obtained average.

The focal axis of the ellipse divides the body blob in two halves. Now the focal axis is divided into nine equal sections (FIG. 20). Perpendiculars to the focal axis, built at the dividing points, longitudinally divide the body blob into nine segments. For each segment, the difference between the areas on either side of the focal axis is calculated. The sum of absolute values of the differences divided by the area of the entire body blob gives the asymmetry of the body. If this obtained asymmetry value is over 6%, the given image is asymmetric enough to be considered, in block 864, it to be a side view of the bee. In order to determine which side it is, the three middle segments on either side of the axis are compared (two perpendicularly hatched areas on FIG. 20). The smaller area comprises the lower (underside) half of the body.

If, in block 864, it is determined that the asymmetry of the image is smaller than a limit, it is necessary to determine whether the image represent back or underside of the bee.

For that, in block 868, the region of the abdomen is used and, using a threshold value (for example 110, if the luminosity range is 256), the image is thresholded into a binary picture and, in block 870, black blobs are eroded by five pixels. The black blobs after the said erosion are the cross-hatched areas in FIG. 18 and FIG. 22. In block 872, the black blobs, which contain more than 200 pixels, are selected and smallest surrounding inclined rectangles are built. If any rectangle with length to width ratio is at least 3 has the angle between longer side and the focal axis of the ellipse within 80 to 100 degrees, it is decided that the image contains the black stripes found along the bee's back, thus the image is one of the bee's back. Conversely, it is underside.

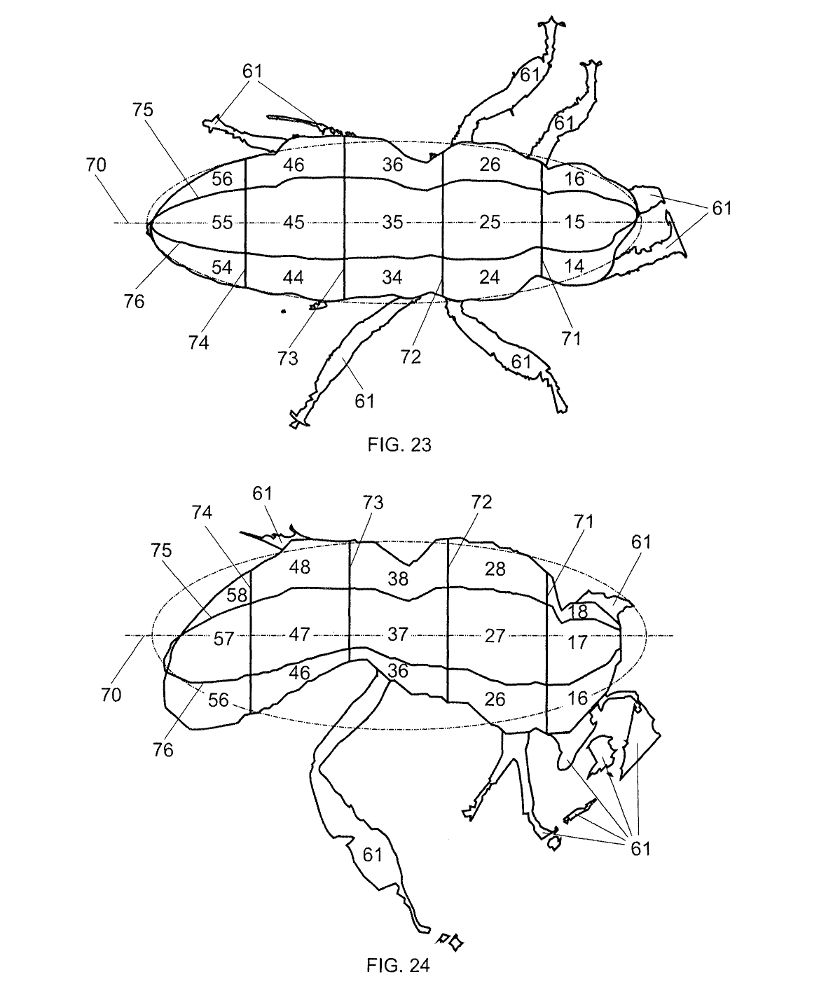

Based on the accomplished determination of the orientation of the body, each pixel of the image is assigned a parameter, in block 876, indicating to which zone of the body it belongs. The zones are assigned two-digit numbers, indicating the position of the zone, where the first digit indicates the segment as shown in FIG. 15 and the second digit indicates the sectors as shown in FIG. 16. For an image taken from underside of the bee, the zones are indicated in FIG. 23 and for an image taken from the right side the zones are indicated in FIG. 24. All pixels that belong to legs regions are assigned the zone 61. In order to assign body zones to the parts of the image of a bee body, the following algorithm is used. The focal axis 70 of the said ellipse (FIG. 23 and FIG. 24) is divided into five equal parts and the perpendiculars 71, 72, 73 and 74, dropped from the dividing points to the contour of the bee body blob mark the boundaries of the zones, along to the focal axis. The first zone from the head-side is assigned the number 1 and the other zones are assigned numbers of increasing value such that the last zone of the abdomen is assigned the number 5. To assign the second digit of the zone identifiers, the body region is divided by the focal axis 70 into two halves and the halves on each side of the focal axis are divided into two equal parts, based on the distance between the contour of the body blob and the focal axis of the ellipse, taken perpendicular to the said axis. The lines 75 and 76 (FIG. 23 and FIG. 24) obtained divide the bee's both half bodies into two parts, comprising four transverse sections. Pixels in the two central sections are assigned their second identification digit depending on whether they are part of a side, back or underside image. The two edge-most sections are assigned the second identification digit depending on the identification of their neighboring sections.

The results, obtained in block 710 (FIG. 7), which assigns each pixel a zone it belongs to, are saved in the image bank 702 (FIG. 13).

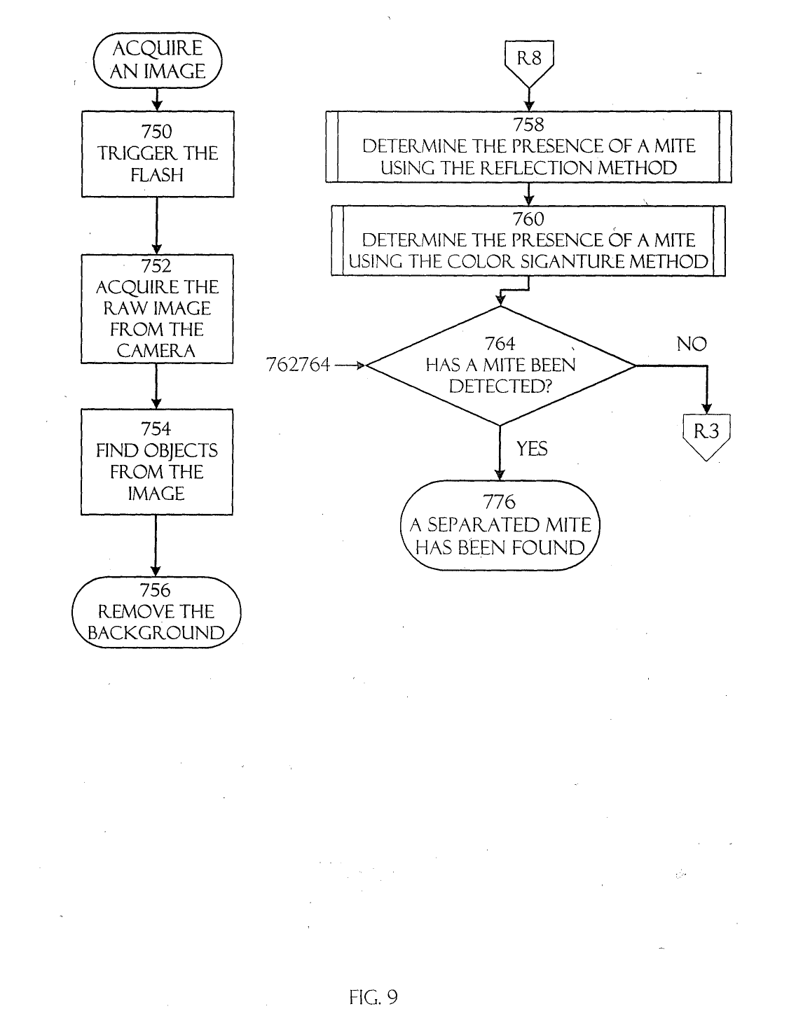

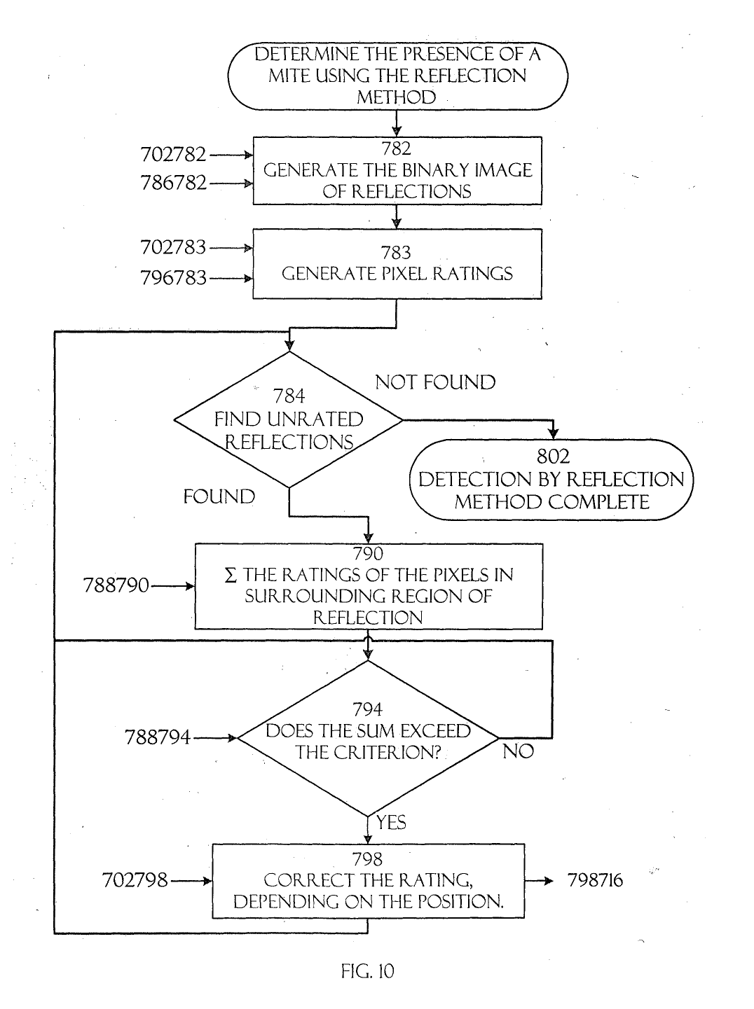

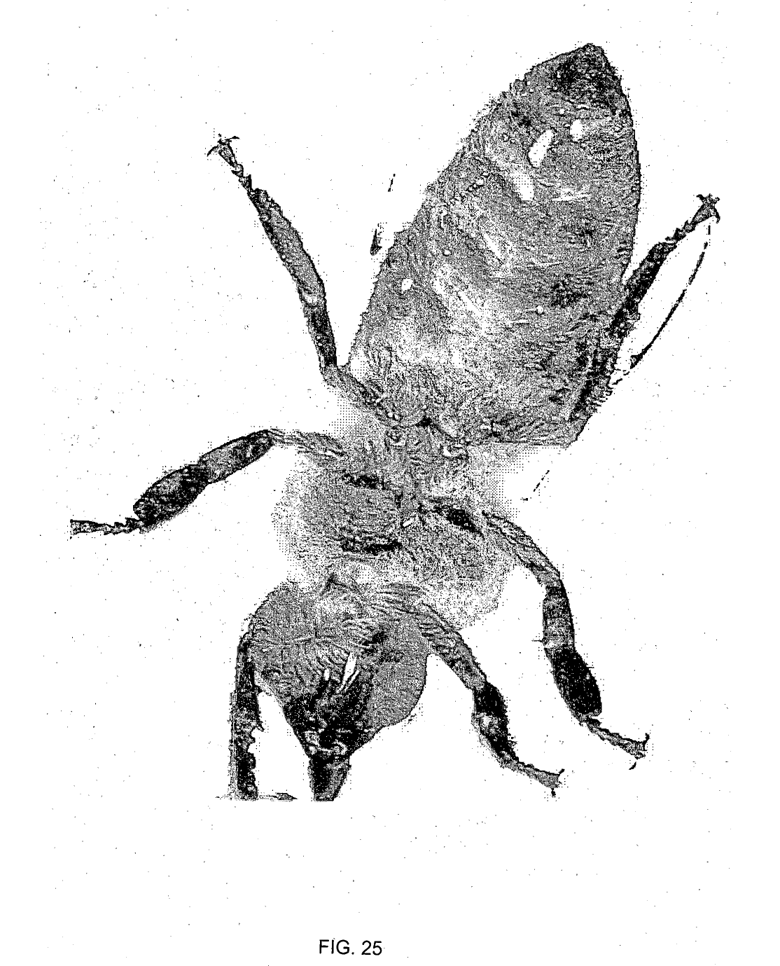

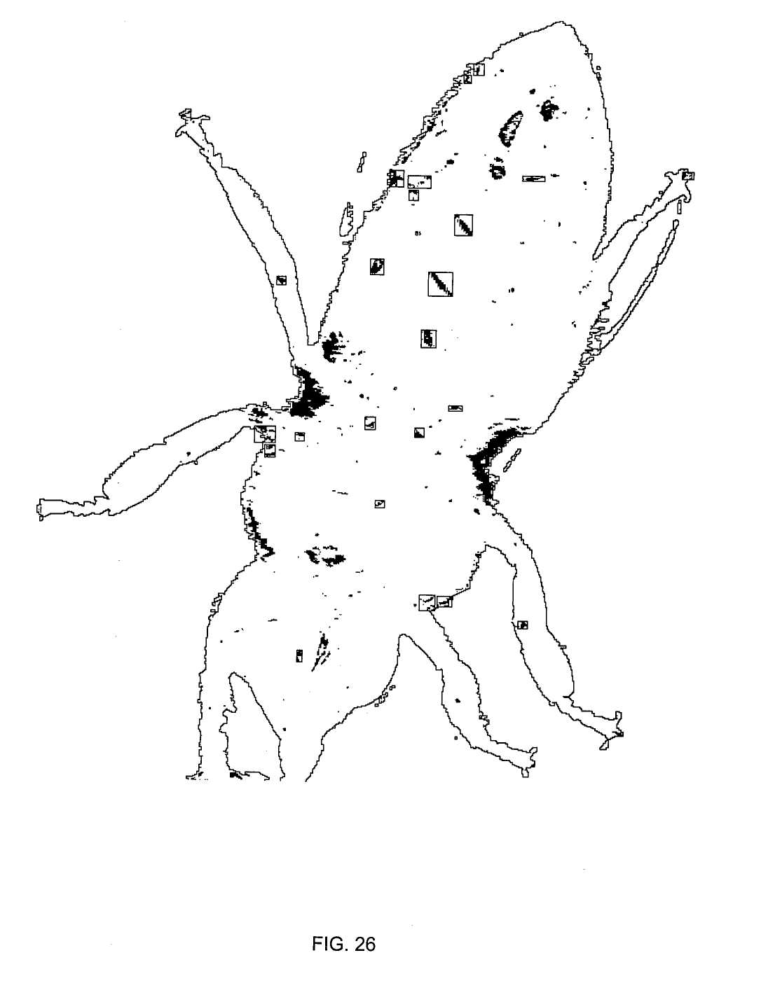

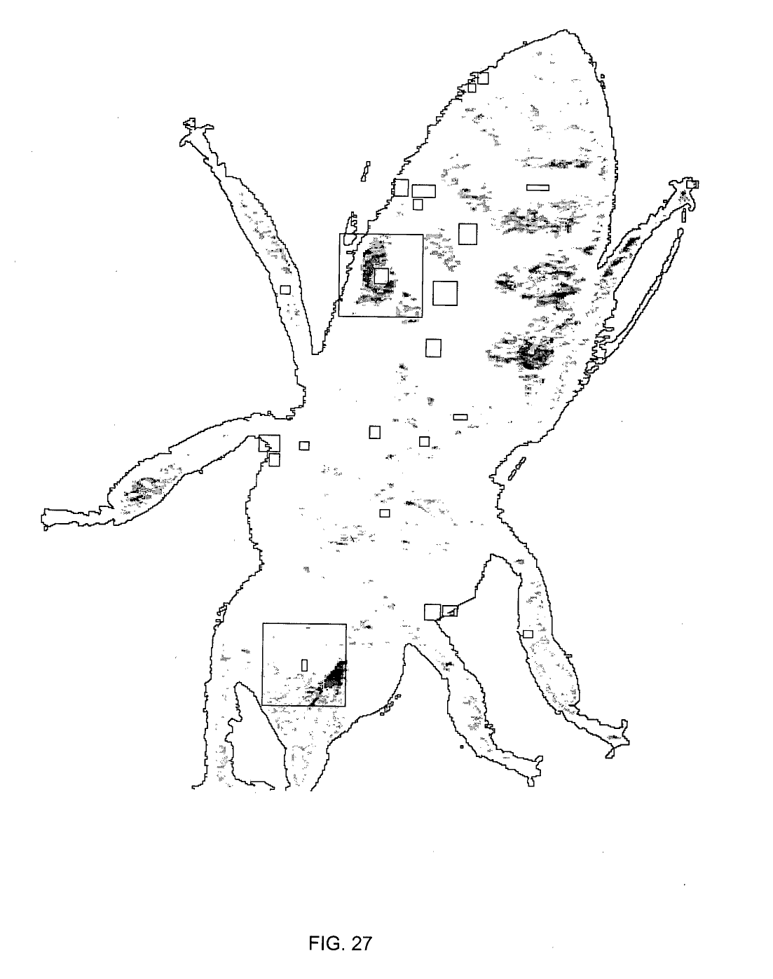

Now the detection of mites through the reflection method (block 714, FIG. 7) takes place as illustrated in the flow chart on FIG. 10. The method is illustrated by regions created in the processing of the image of FIG. 25, as shown in FIG. 26 and FIG. 27. Block 782 uses the images saved in image bank 702, from which a binary image is first created, where each bit indicates whether the respective pixel is part of a reflection or not. A reflection is considered to be a blob, whose color values are within a given RGB range. This range is described using three-dimensional RGB color binary table 786 (FIG. 14), where ‘1’ represents the color values of a reflection. The black areas on FIG. 26 indicate the pixels from image shown in FIG. 25, which match the reflection criteria. In further analysis, blobs of 10 to 100 pixels are selected and smallest surrounding upright rectangles are determined for them (illustrated in FIG. 26). In block 783, each pixel is assigned a rating, based on the color table 796 (FIG. 14). The said rating represents the proximity between the color of the pixel and the characteristic color of a mite. The black pixels in FIG. 27 are pixels with a rating of at least 100, while the gray pixels have a rating of at least 20.

In FIG. 26 tens of reflections are seen, of which 22 have been marked with surrounding rectangles (as they match the size criterion of 10 to 100 pixels). All the reflections that matched the criterion are selected and used in block 784. Block 790 assigns the center of the said surrounding rectangle as the center point for the reflection and takes the ratings, assigned in block 783, of the pixels surrounding the center point, within a square of side 50 pixels. When determining the resulting rating for the square, surrounding the reflection, the values for each pixel are multiplied by a scale factor that decays monotonically with the distance of the pixel from the center of the reflection. The scaled ratings are summed up over all the pixels within the 50×50 square. In block 794 (FIG. 10) the sum of ratings, which indicates the proximity of the color of the reflected region to the characteristic color of mites, is compared to criterion for the sum of ratings obtained from block 788 (FIG. 14). The rectangles surrounding reflections, illustrated in FIG. 27, have weighted sums of over the criterion 4000, which allows for further analysis. Taking the reflection center-point, it is determined, by use the table from image bank 702 (FIG. 12), the zone of the body, in which the given reflection is located. Block 798 (FIG. 10) contains a table indicating the probability of detecting a mite in a given zone of the bee's body, and, based on that, adjusts the rating obtained from block 790, to indicate the probability of a mite being present in a given reflection. For example, in zone 15 there is a peak, and any rating in this zone is nullified. If a mite, separated from the bee, is detected, the rating adjustment is relinquished. The adjusted rating and the reflection body zone's number are saved in table 716 (FIG. 13), after which the program returns to block 784 (FIG. 10), to evaluate the other reflections. The process ends, when there are no more unrated color signatures.

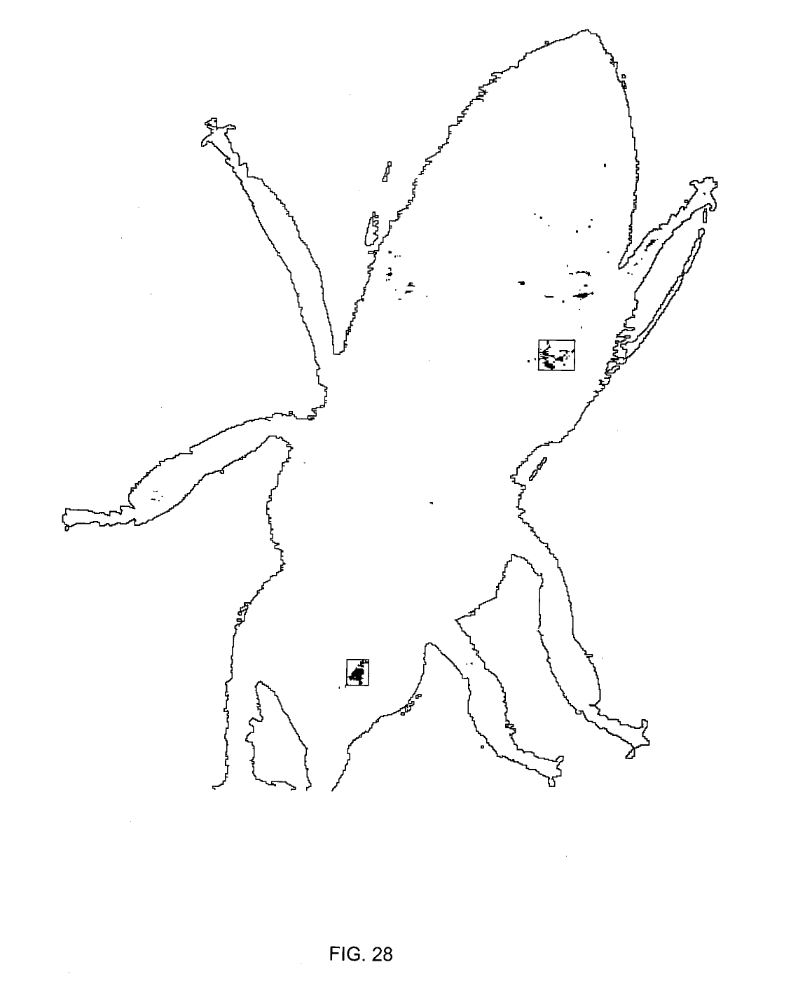

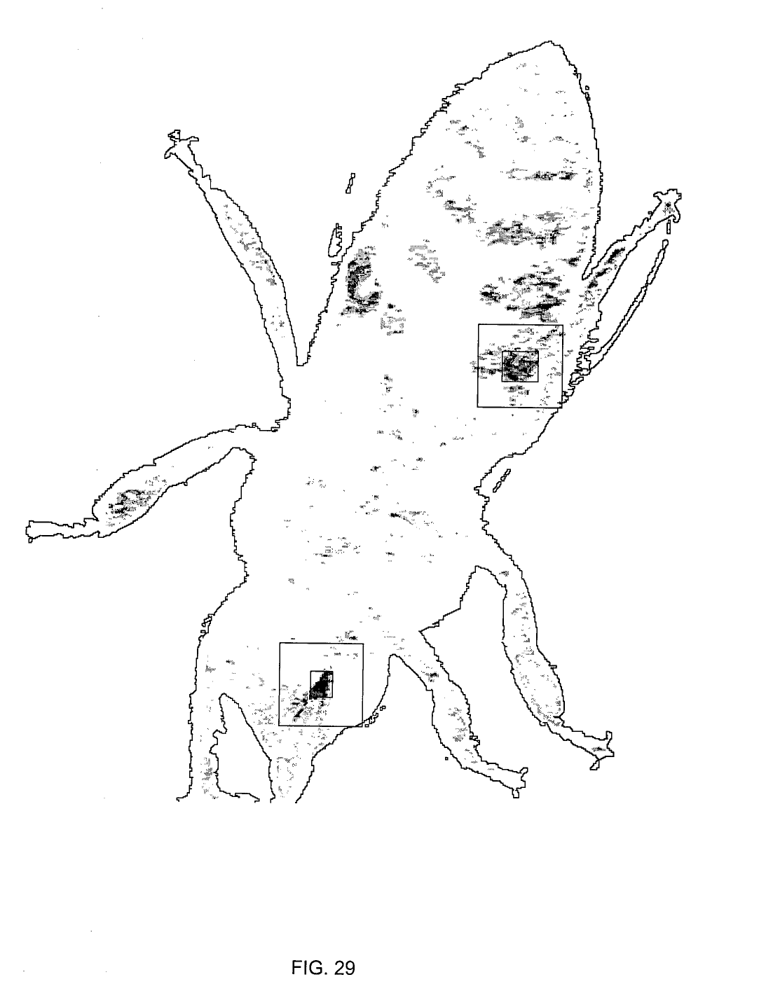

Further begins the mite detection by color signature method, according to block 718 (FIG. 7), which comprises of the procedures indicated in flow chart on FIG. 11. The method is illustrated by regions created in the processing of the image of FIG. 20, as shown in FIG. 28 and FIG. 29. Block 810 uses the digital image stored in image bank 702, firstly to generate a binary image of the bee, where each bit indicates the presence or absence of the color signature in a pixel. The color signature is considered to be a blob, whose color values are within the defined RGB limits indicating colors, which are commonly found in mites, but rarely in bees. In order to define the parameters and limits for the color signature, a three-dimensional binary table, 814 (FIG. 14), of RGB colors is used, where color values considered to be the signature have the value ‘1’. The black areas on FIG. 28 indicate the pixels from image shown in FIG. 25, which match the criteria for the color signature. Here a blob is considered to be cohesive, when pixels of the blob are neighbouring to some other pixel of the blob or separated from each other by no more than one pixel not belonging to the blob. In further analysis the color signatures, which consist of 10 to 100 pixels are selected and smallest surrounding upright rectangles are determined for them (illustrated in FIG. 28). In block 811 (FIG. 11), a rating is assigned to each pixel, based on the color signature table 796 (FIG. 14). The said rating indicates the proximity between the color of the pixel and the characteristic color of a mite. FIG. 29 illustrates the results of the analysis, where black pixels having a rating of at least 100 and gray a rating of at least 20. The illustration shows two color signatures surrounded by rectangles, and many other color signatures, which are ignored. Block 816 (FIG. 11) sequentially takes on color signatures, until all the signatures have been analyzed. Block 824 assigns the center of the surrounding rectangle as the center point of the color signature and takes the ratings, assigned in block 811, of the pixels surrounding the center point, within a square of side of 50 pixels. When determining the resulting rating for the square, surrounding the color signature, the values for each pixel are multiplied by a scale factor that decays monotonically with the distance of the pixel from the center of the color signature. The scaled ratings are summed up over all the pixels within the 50×50 square. In block 826 (FIG. 11) the sum of ratings, which indicates the proximity between the color of the given area and the color signature of mite, is compared to criterion for the sum of ratings obtained from block 818 (FIG. 14). The rectangles surrounding color signatures, illustrated in FIG. 29, have weighted sums of over the criterion 3500, which allows for the further analysis. Taking the color signature center-point, it is determined by use the table from image bank 702 (FIG. 12) the zone of the body, in which the given color signature is located. Block 830 (FIG. 11) contains a table indicating the probability of detecting a mite in a given zone of the bee's body, and based on that, adjusts the rating obtained from block 824, to indicate the probability of a mite being present in the color signature. The same as it is in the block 798 (FIG. 10), any rating in zone 15 is nullified, and if a mite, separated from the bee, is detected, the rating adjustment process is relinquished.

The adjusted rating and the body zone number of color signature are saved in table 720, after which the program returns to block 816 (FIG. 11), to repeat the color signature rating process on the next color signature. The process ends, when there are no more unrated color signatures.

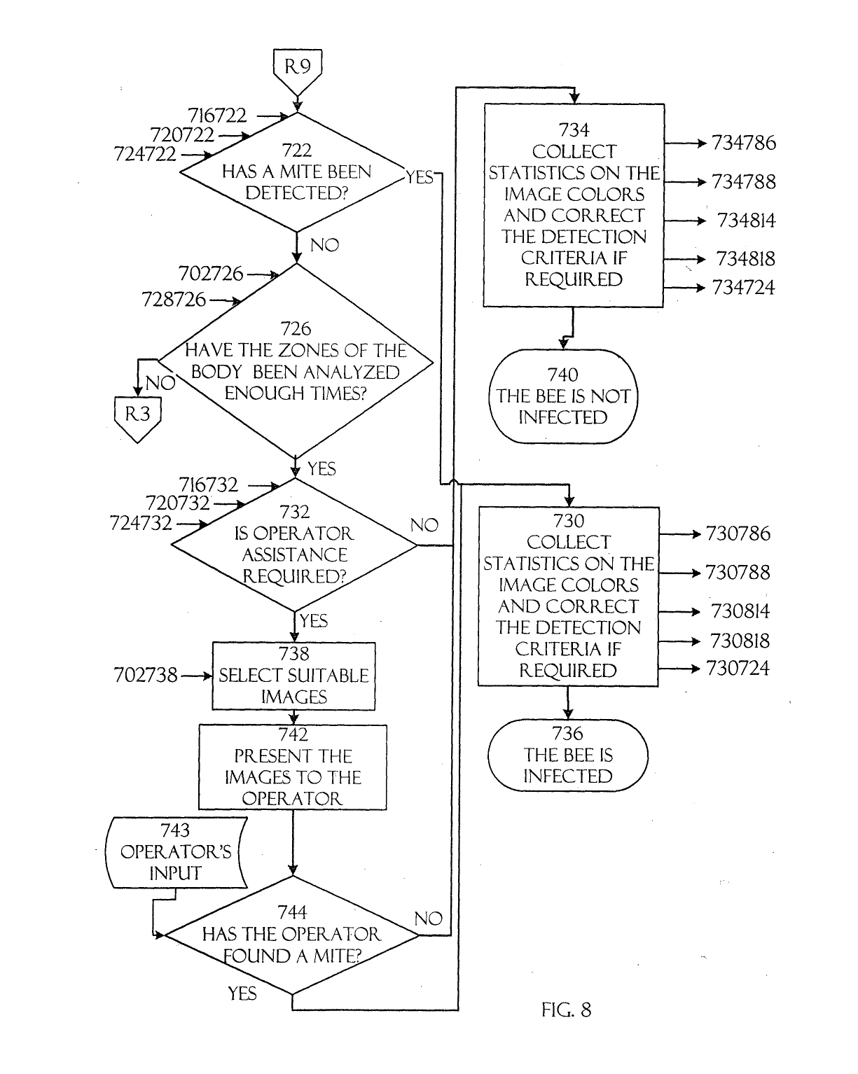

The process proceeds to block 722 (FIG. 8), where, using the ratings, calculated in blocks 714 (FIG. 7) and 718 and stored in tables 716 (FIG. 13) and 720, as well as the criteria saved in table 724, the presence of the mite is determined. If ratings from tables 716 and 720 indicate, with enough high certainty, the presence of a mite (a summed rating of over 6000), it is determined that the current bee is infected and the program proceeds to block 730 (FIG. 8). If such a high level certainty indication is not found, the program attempts to find, in any body zones, multiple positive (i.e. groups from blocks 794 (FIG. 10) or 826 (FIG. 11), which had high enough ratings to allow for further analysis) ratings, which are added up and divided by the square root of the number of additives. If the result is higher than the threshold 6000, again, it is determined that the current bee is infected and the program proceeds to block 730. If the obtained rating is not above the threshold, it is checked up, in block 726, whether the data of analyzed body zones of the current bee saved in the image bank (block 702 FIG. 13) match the criteria of table 728 (FIG. 13). If not, the program returns to block 704 (FIG. 7), to begin searching for a mite on a new image. If the body zones have been analyzed enough, it is determined, in block 732, using all ratings from table 716 and 720 as well as criteria saved in table 724, if there are any color signature or reflection rating, which are close to the required threshold, but require an operator's examination. If such color signatures or reflections exist, images are chosen, in block 738 (FIG. 8), to be presented to the operator, where the reflections or color signatures are found, as well as a range of other images, which contain the same body zone where reflections or color signatures are detected. Also, images taken from different orientations are presented, so that the operator has pictures of all different zones of the current bee's body residing in the image bank. Presentation of the images to the operator in block 742 takes place on a split screen, where multiple images, preferably of different orientation, are shown at the same time. Block 744 waits for positive or negative decision from the operator and proceeds, consequently, to either block 730 or 734, where the detection procedure ends. The procedure proceeds from block 722 to block 730 without the aid of the operator, if the mite has been detected with enough certainty, or from 732 to block 734, if the absence of the mite has been made certain.

Due to the fact that various strains of bees have various body colors and that the colors of varroa mites may differ, this detection program works adaptively, collecting statistics, in blocks 730 and 734 (FIG. 8), on the characteristics colors on images with detected mites, as well as the characteristics colors and their relative location on images, which have proved the absence of mites. In accordance, if required, collected statistics is used for adjustment of the reflection characteristics in the RGB color space table 786 (FIG. 14), color signature characteristics in the RGB table 814 and the tables 788 and 818 of criteria used for reflection and color signature detection. If the operator finds a mite, the criteria for the sum of the rating in the table 724 (FIG. 13) are reduced by 0.1 percent. If the operator considers a bee to be uninfected, the criteria for the sum of ratings in the table 724 are increased by 0.1 percent.

If a small object is detected in block 706 (FIG. 7), the program implements branch R8 on FIG. 9, where the procedure for detecting mites, according to blocks 758 and 759 on FIG. 10 and FIG. 11, is implemented. If a separated mite is not detected, the procedure returns to block 704 (FIG. 7). If a separated mite is detected, the procedure stops in block 776 (FIG. 9).

### Example 2

### The Second Embodiment of the Device

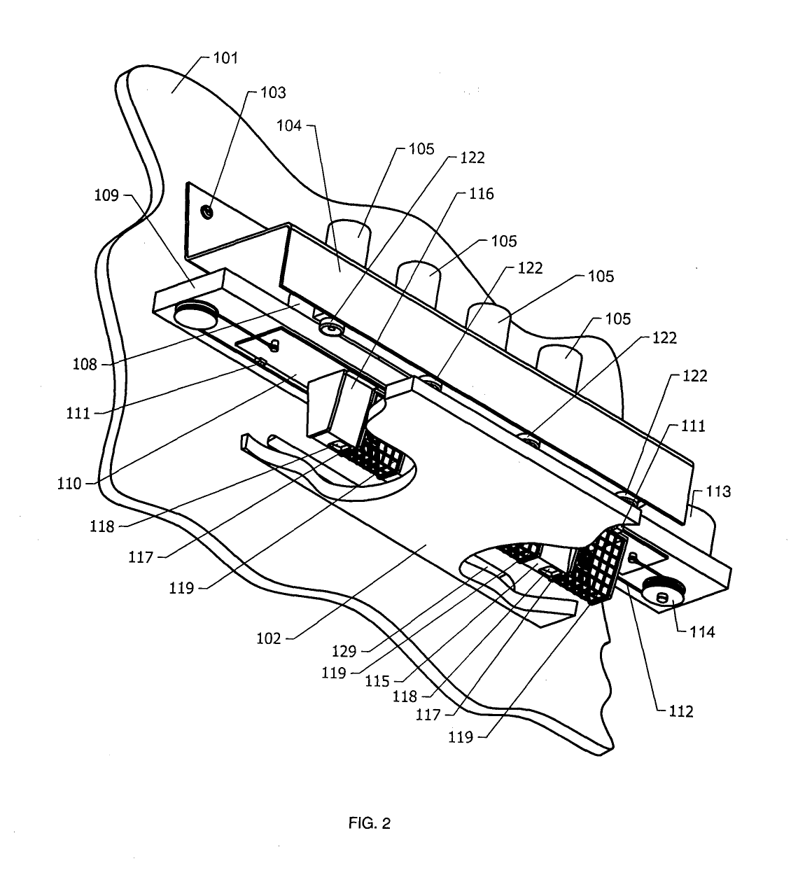

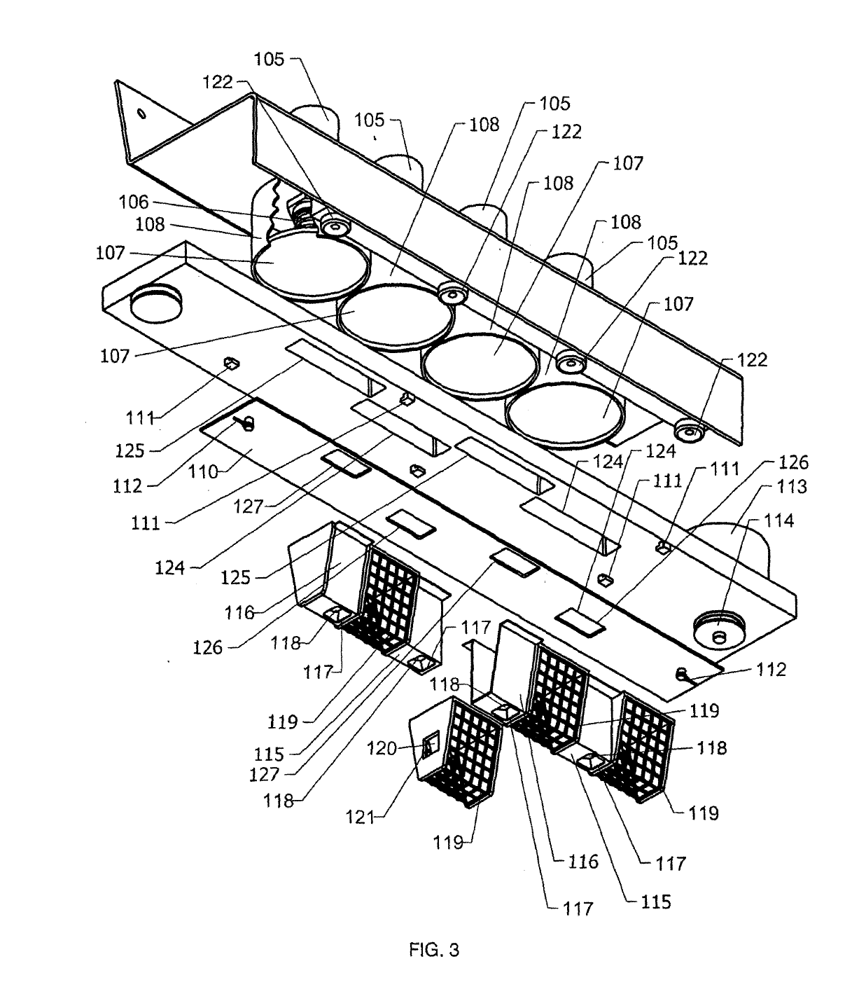

The device (FIG. 2, FIG. 3) is attached to the front wall 101 of the hive above the landing board 102, with screws 103. The device consists of a main body 104 that is overhanging as a cantilever above the landing board 102, and has four solenoids 105 been fastened. To the core of the solenoids 105, disk-shaped pistons 107 are fastened, which are arranged in cylinders 108. In no-current state of the solenoids 105, the pistons 107 are, under the pressure of the springs 106, in the lower position and the cores are pulled to their ultimate position out of the solenoids 105. The lower ends of the cylinders 108 are connected to a connecting plate 109, which has central air channels 124 and side air channels 125. On the lower side of the connecting plate 109, there is a sliding plate 110, which is directed by guides 111. Onto the shaft of a stepper motor 113, a driving wheel 114 is placed, which is connected to the sliding plate 110 via a cable 112. The sliding plate has central openings 126 and openings on the sides 127. On the lower side of the sliding plate there are nozzle assemblies for the central channels 115 and nozzle assemblies for the side channels 116. At the bottom of the nozzle assemblies 115 and 116, there are suction nozzles 117, which have valves that open inwards 118. The range of movement of the sliding plate 110 along the connecting plate 109 is larger than the distance between the nozzles 117, so that bees moving along the landing board towards the hive entrance pass through the range of at least one nozzle. Beside the nozzle assemblies 115 and 116 there are collection cages 119, which have in their end walls adjacent to respective nozzle assembly entry holes 121, equipped with inwards-opening valves. Though in FIG. 2 and FIG. 3, the walls of the collection cages 119 are, for the sake of design visibility, made from light lattice, actually the walls should be of fine lattice, to prevent bees as well as mites from escaping. At the front of the main body 104, there is a camera assembly 123, which involves an image processor together with video memory and four cameras. The cameras are equipped with video-sensors and objective lenses 122. The fields of view of the said cameras overlap, such that every bee going into the hive does so in view of two cameras simultaneously. The said image processor is connected via electronic drivers to the stepper motor 113 and electromagnets 105 as well as to a computer network, via well-known connectivity units.

The image processor in the camera assembly 123 observes the landing board. Enough images are acquired and saved of each bee arriving to the hive, to determine by image processing the presence or absence of varroa mite on the bee's body. The procedure for detecting the presence of a varroa mite is similar to one described with the first embodiment of the device. The images acquired by cameras above the landing board may contain multiple bees, in which case the procedure of detecting the location of the body zone and search for reflections and specific color signatures is run on each object that can be differentiated from the background and is of a bee's size. In order to adapt to changing illumination conditions, known in the art computer vision techniques are used. Because the movement of bees cannot be restricted, the device uses the result obtained from the images by the time a given bee reaches arena of the suction nozzles 117. If the bee is infected by varroa mite, the image processor calculates the direction and amount of movement required to move the sliding plate to the position, so that one of the nozzles 118 is positioned close above the bee, and issues the required command to the stepper motor 113 driver. When the chosen nozzle reaches the bee, the image processor activates the respective solenoid 105 driver. The said driver generates a current impulse, by which the selected solenoid's anchor and piston 107 move quickly up. This creates a vacuum in the respective cylinder 108 and the air current flowing into the respective nozzle forces the bee through the nozzle. When the current impulse ends, the spring 106 returns the piston 107 back to its initial, lower position. Air exits from the cylinder 108, closing the valve 118 and opening the valve 120, and the bee is forced through opening 121 into the respective collection gage. After that, the image processor resumes analyzing of remaining bees, saving and processing the subsequent images from the cameras. At the same time, the image processor transmits to the computer network data regarding the bees in the collection gages, so that the bee-keeper is informed of their occupation and can empty them in time.

### Example 3

### The Third Embodiment of the Device

The device's third embodiment comprises all the components from second embodiment, however the landing board is made from a transparent material and below it is located an extra, underside camera assembly, similar to previously described camera assembly, except that it is directed upwards from underneath of the landing board, giving a view of the bees' undersides. The camera assembly, placed as described in the second embodiment, shall be referred to, here, as the upside camera assembly. The device of the third embodiment works similarly to the device of the second embodiment, except that the image processor of the upside camera assembly has an additional connection to the image processor of the underside camera assembly. The image processor of the underside camera assembly observes and analyses images of bees, moving on the landing board, similarly to the image processor of the second embodiment and forwards the coordinates of infected bees to the upside camera assembly image processor, after which the upside camera assembly image processor takes over the observation of the identified bees. The separation of infected bees identified by both image processors is controlled by the upside camera assembly image processor, using the stepper motor and solenoids as previously described with the second embodiment.

### Example 4

### The Fourth Embodiment of the Device

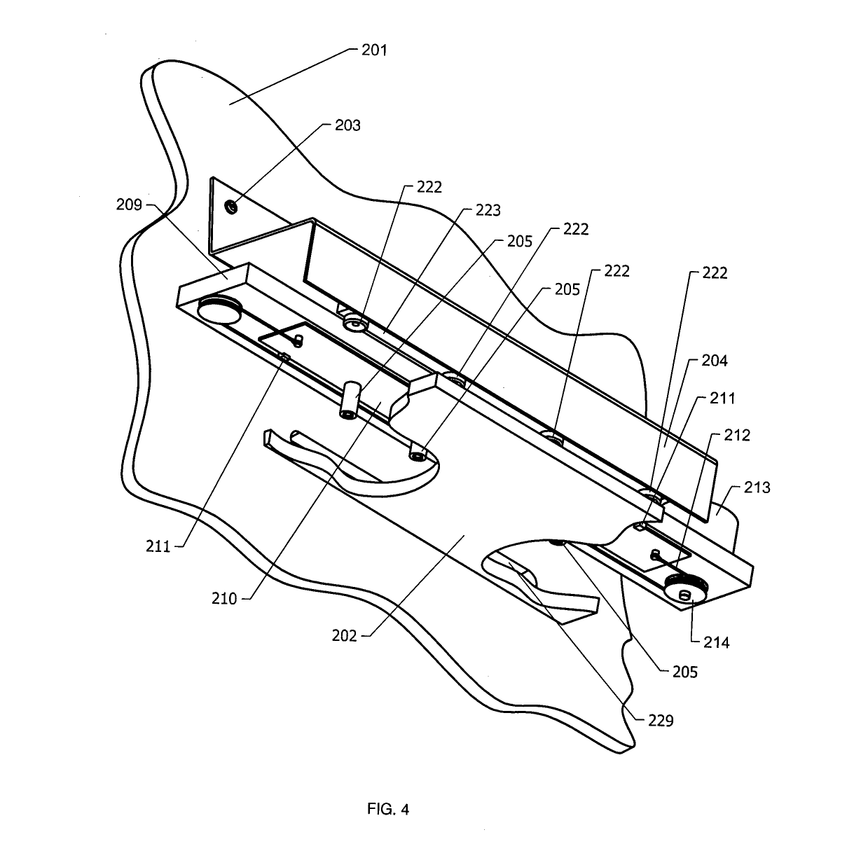

The device (FIG. 4) is attached to the front wall 201 of the bee hive above landing board 202, using screws 203. The device comprises of a main body 204 that is overhanging as a cantilever above the landing board and attached to it connecting plate 209. At the bottom side of the connecting plate 209 is a sliding plate 210, which is directed by guides 211. On the shaft of a stepper motor 213 is a driving wheel 214 is placed, which is connected to the sliding plate 210 via a cable 212. On the bottom side of the sliding plate 210 are laser modules 205, which comprise of laser diodes and collimator lenses. The range of movement of the sliding plate 210 along the connecting plate 209 is larger than the distance between the laser modules 205, so that the bees moving along the landing board towards the hive entrance pass through the range of at least one laser. At the front of the main body 204 there is a camera assembly 223, which involves an image processor together with video memory and four cameras. The cameras are equipped with video-sensors and objective lenses 222. The fields of view of the said cameras overlap, such that every bee going into the hive does so in view of two cameras simultaneously. The said image processor is connected via electronic drivers to the stepper motor 213 and laser modules 205, as well as to a computer network, via well-known connectivity units.

The image processor in the camera assembly 223 observes the landing board similarly to the device in the second embodiment. Enough images are acquired and saved of each bee arriving to the hive, to determine by image processing the presence or absence of varroa mites on the bee's body. Bees infected by a varroa mite are observed until they reach the arena of laser modules 205. Then the image processor calculates the direction and amount of movement required to move the sliding plate 210 together with laser modules to the position that one of the laser diodes 205 is positioned close above the bee and issues the required command to the stepper motor 213 drive. When the chosen laser module reaches the bee, the image processor generates a command via the respective driver to the laser module to emit a low-power beam. The focused laser beam creates a dot, which is visible on the field-of-view of the camera and the image processor calculates the distance between the center of the dot and the position of the varroa mite. Correcting the position of the stepper motor and waiting for the progressive movement of the bee, until the calculated distance is minimal, the image processor activates the laser module on full power generating a impulse of radiation, that kills the varroa mite by heat.

The image processor then resumes saving and analyzing images from the cameras. At the same time, the image processor transmits data to the computer network regarding the analyzed bees and the killed varroa mites.

### Example 5

### The Fifth Embodiment of the Device

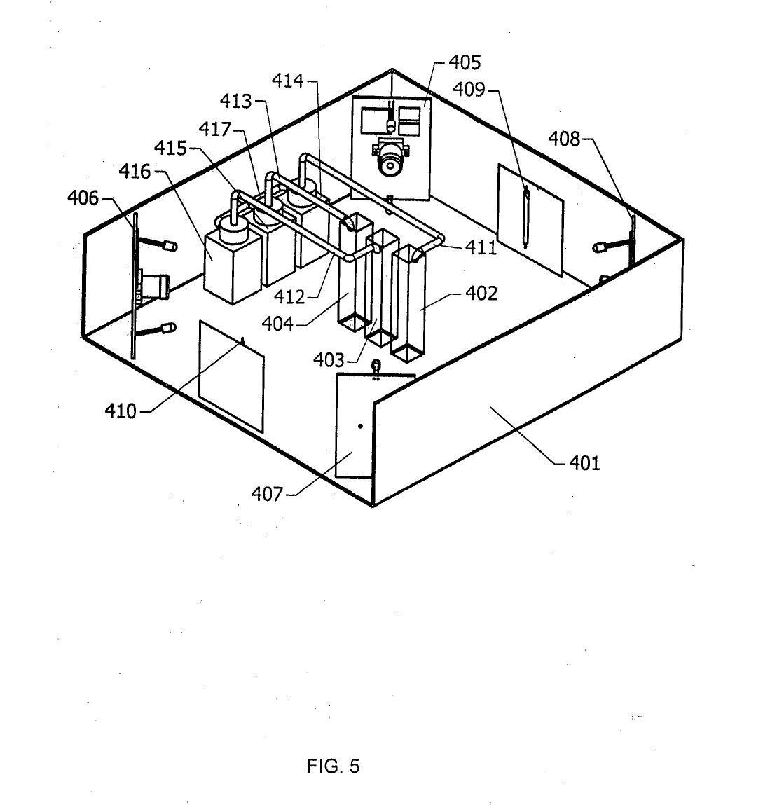

The device according to the fifth embodiment comprises of a main body 401 (FIG. 5) (on the drawing, the front and top panels have been removed). At the bottom of the main body there are three openings, which are connected to three vertical channels 402, 403 and 404, made from transparent material. Similar openings, connected to the said transparent channels, are on the top panel (removed in the drawing). On the corners of the main body there are camera assemblies 405, 406, 407 and 408, which each comprise of one digital camera, two infra-red emitters and electronic components that connect the camera and the emitters to an external image processor, via a high-speed data channel Gigabit Ethernet connection. All three of the said vertical channels are in field-of-view of the four cameras. In order to obtain a focused image of the channels at various distances, the video-sensors in the cameras are placed at the required angle. Near the front and back panels of the main body there are gas discharge lamps 409 and 410, complete with reflectors, which are connected to the image processor, via the required driver (not included in the drawing). The said transparent channels are equipped with gas pipes 411, 412 and 413, which are connected to solenoid valves 414, 415 and 416. The solenoid valves are connected, via the gas pipe 417, to an external pipeline and through that to an external CO₂ reservoir (not included in the drawing). The solenoid valves are connected, via a control block (not included in the drawing), to the said image processor.

The device is placed on a container of bees, in such a way that the bees can only exit the container through the transparent channels 402, 403 and 404. Under control of the image processor, the infra-red emitters begin generating short light impulses, which are synchronized to the cameras. In order to prevent the infrared radiation from shining directly into the cameras, during the exposure, only two camera assemblies work at the same time: the front two (406 and 407) and then the back two (405 and 408) camera assemblies. Each image, exposed by the infra-red transmitters, is analyzed by the image processor, which detects the presence and location of the bees in the channels 402, 403 and 404. If a bee is in any channel completely within field of view of the cameras, the acquisition of color images begins by two cameras at a time, alternating the front and then the back cameras, with the gas discharge lamps 409 and 410 respectively exposing the images. The image processor analyses the images with the algorithm described in the first embodiment, with the reflection (FIG. 8) and color signature (FIG. 9) methods. The device can be implemented without the module, which determines the orientation of the bee. In this case, the function, which corrects the results obtained from the reflection and color signature methods based on the orientation of the bee's body, is skipped (block 798 FIG. 10 and block 830 FIG. 11). The taking of color images and the detection of mites from them takes place at a speed of five image sets (20 images) per second. If, based on the consecutive images obtained from a certain channel, the signs of mite presence are determined whose cumulative rating provides a high probability of there being an infected bee in the given channel, the respective solenoid valve 414, 415 or 416, the gas pipe from which is connected to the channel with the infected bee, is opened. Through the opened solenoid valve CO₂ from the external reservoir is directed to the channel with the infected bee. The dosage of CO₂ is chosen to be enough to make the bee temporarily paralyzed and, under the force of the gas flow the bee will be pushed down the channel to the lower reservoir. If there are the other bees in the channel, they all get temporarily paralyzed and are pushed down into the lower reservoir. The lower reservoir is provided with venting meshes, and in fresh air, the bees soon regain full consciousness and start to climb up the channels 402, 403 and 404 again.

The result is that only the uninfected bees can get to the higher reservoir and the infected bees stay in the bottom reservoir. After the operation of the device is finished, the bees in the bottom reservoirs can by treated by known methods.

### Example 6

### The Sixth Embodiment of the Device

The device according to the sixth embodiment partly overlaps with the device of the fifth embodiment. The device comprises of a main body 501 (FIG. 6) (the top panel has been removed in the drawing). At the bottom of the main body are three openings, which are connected to three vertical channels 502, 503 and 504, made of transparent material. Similar openings, connected to the said transparent channels are on the top panel (removed in the drawing). On the corners of the main body there are camera assemblies 505, 506, 507 and 508, which each comprise of one digital camera, two infra-red emitters and electronic components that connect the camera and the emitters to an external image processor, via a high-speed data channel Gigabit Ethernet connection. All three said vertical channels are in field-of-view of the four cameras. In order to obtain focused images, the camera video sensors are placed at the required angle. Near the front and back panels of the main body there are gas discharge lamps 509 and 510, complete with reflectors, which are connected, via the required drivers (not included in the drawing), to the image processor. The said transparent channels are equipped with lower electromagnet gates (511, 512 and four others, hidden in the drawing) and upper electromagnet gates (513, 514, 515, 516, 517 and 518). The electromagnet gates are connected, via a control block (not included in the drawing), to the said image processor. The electromagnet gates are shown, in the drawing, in the closed state. The flanks of two opposite gates are hold by springs away from the electromagnets and form a narrow gap, through which bees cannot pass. When the electromagnets are activated, the flanks are pulled against the electromagnet and the gap between them is wide enough for a bee to pass freely. The springs closing the gates are weak enough to not injure a bee stuck between the flanks, as the gates close. In the main body there is a stepper motor 519, with a driving wheel 520. In the groove of the driving wheel a cable is arranged, which forms a closed loop, stretched over grooved passive wheels 522, 523, 524, 525, 526 and 527. Laser frames 528 and 529 are fastened to the cable 521 and to them are fastened laser modules 530, 531, 532 and 533. The laser modules are connected to an external controller, via a flexible cable (not shown on the drawing), which is controlled by the image processor. The stepper motor 519 is also connected to a controller, controlled by the image processor.

In the channels 502, 503 and 504, there is a transversal rod 534, which forms a step, where a bee is forced to climb, allowing for a better view of the area between the thorax and abdomen.

The device is placed on a container of bees, in such a way that the bees can only exit the container through the transparent channels 502, 503 and 504. Under control of the image processor the lower electromagnet gates open and the infra-red emitters begin generating short infra-red light impulses, which are synchronized s to the cameras. The upper electromagnet gates 513-518 remain closed. In order to prevent infra-red radiation from shining directly into the cameras, the cameras work in alternating pairs, first the two in the front (506 and 507) and then the two at the back (505 and 508). Each picture exposed by the infra-red light is analyzed by the image processor, to determine if there is a bee in either of the channels 502, 503 or 504 and to determine its position. The position of the bee is determined by the center of gravity of the bee in the image. When a bee has entered a channel, the respective lower electromagnet gate is closed and the process waits until all the channels have a bee, or until the timeout of one minute is exceeded. After that the cameras begin taking color images alternating between the two in the front and the two in the back, exposed by the respective gas discharge lamps 510 and 509. The image processor analyses the obtained images as described in the first embodiment, using the reflection (FIG. 8) and color signature (FIG. 9) methods. The taking of the color images and the detection of mites from them is done at a speed of five picture sets (20 pictures) per second. If it is determined, from multiple images, that there is an infected bee in a given channel, a process is run to kill the discovered mite with a laser beam.

First, the image processor determines which laser module is in the correct orientation to kill the mite. If the mite is only seen by one camera, the laser with the same direction of optical axis as the camera is used. For example, a mite found by the camera module 506 will be killed by the laser module 533. As well, the discovered mite will be killed with the help of the camera module it was discovered by. If the mite is in view of multiple cameras, the camera is chosen, where the horizontal distance between the mite to the bee's center of gravity is minimal. In the following images, the image processor observes the movement of the bee as well as the movement of the identified object sharing the signs of a mite in relation to the position of the bee, in all the camera images. If the distance between the mite and the bee's center of gravity increases, another camera module may be chosen.

The arena of the laser beams include the transverse bar 534, in order to allow for the destroying of mites that are between the thorax and abdomen of a bee. When the bee approaches the arena of the laser beams, the image processor chose which laser to use and positions it, using the stepper motor 519, to the horizontal position of the mite sign. The chosen camera module acquires images, at the rate of 120 pictures per second, while synchronously to the camera the chosen laser module generates low-power impulses. The image processor detects, on each picture, the horizontal position of the dot from the laser impulses and the detected signs of the mite and determines the necessary correction and corrects by use of the stepper motor the position of the laser. By extrapolation the movement of the mite sign caused by advancing of the bee, the image processor determines the moment, when the laser beam should be at the mite position. At that moment the laser impulse of full power is generated to kill the mite by arising heat. If, through the movement of the bee, the position of the mite is moved out of view of the chosen camera, another camera should be chosen and accordingly to reposition the laser modules. If the bee passes over the arena of the laser beams, it cannot, due to the closed gates, exit the channel and, at some point, the bee will return and the procedure continues, as described above.

If a bee is infected by multiple mites, or if multiple infected bees are in the same channel, the mites are destroyed one at a time, as described above. When all the mites infecting a bee have been killed, the gates at the top of the channel are opened and the bee let free to exit into the upper reservoir.

### Example 7

### The First Embodiment of the Method

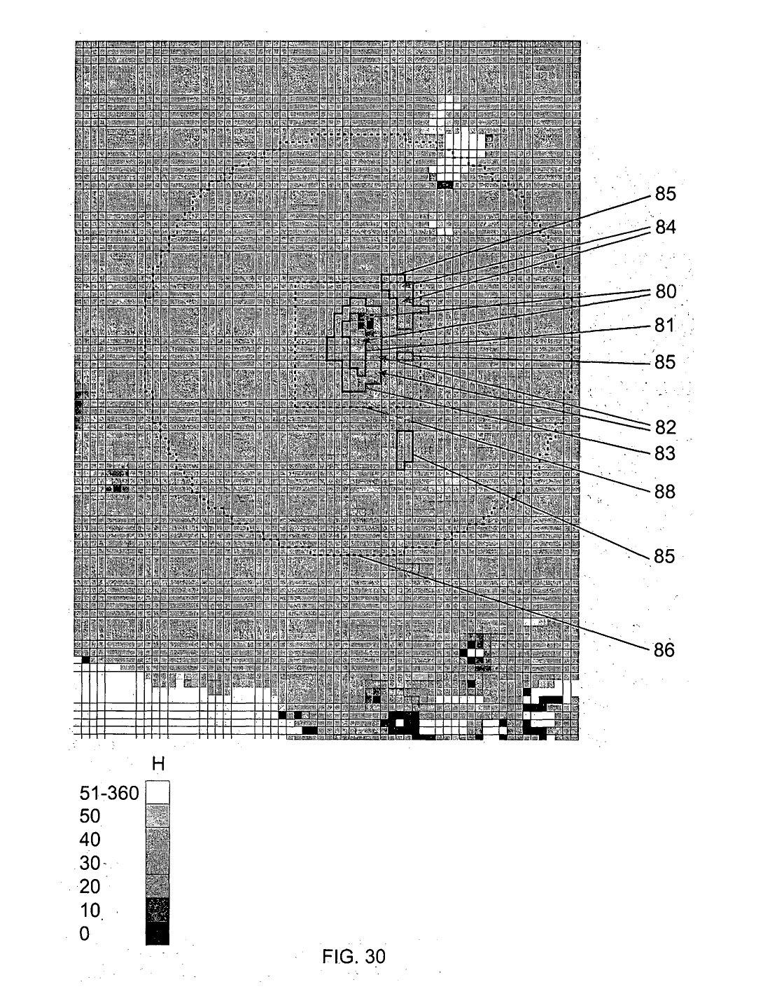

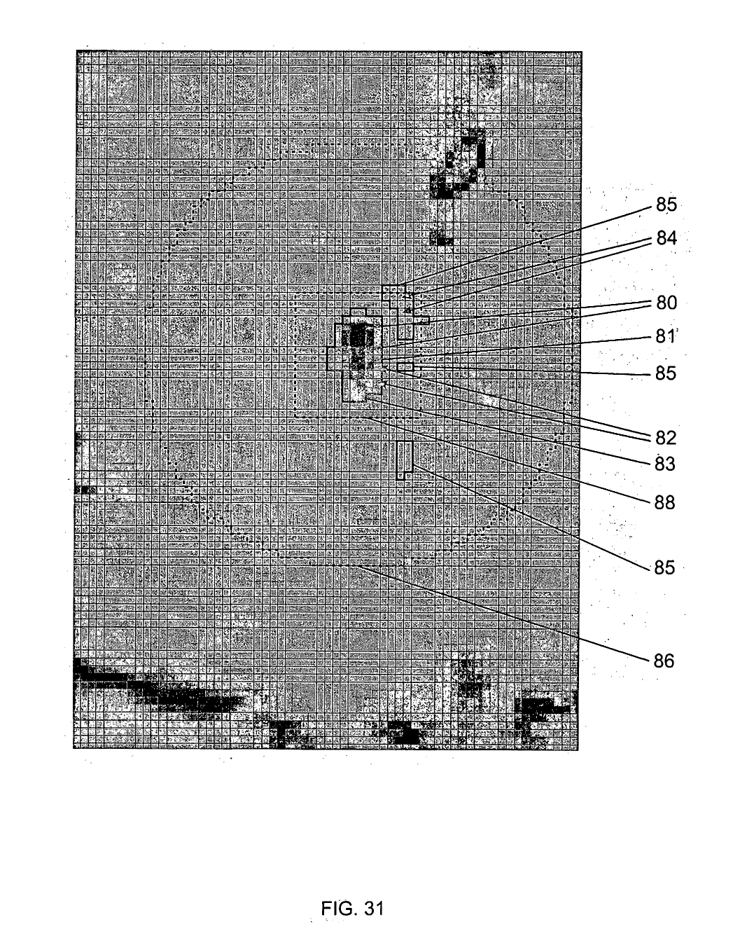

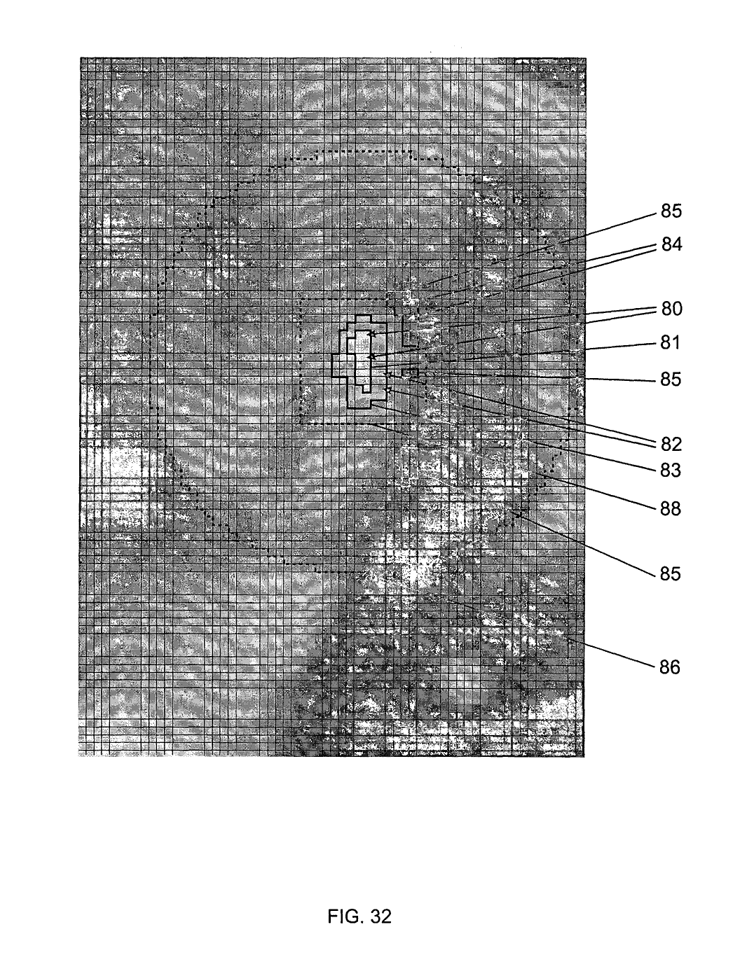

The first embodiment of the method is illustrated in FIG. 30, FIG. 31 and FIG. 32. As the color images are used in processing, the different color presentation systems can be used. The raw RGB image directly from the camera sensor is appropriate to use in an orthogonal three-dimensional space, and select in it specific color value regions for object detection. The HSB color system, however, were the initial RGB image is converted to the parameters Hue, Saturation and Brightness, enable the selecting of narrow hue, saturation and brightness ranges, where objects are clearly differentiated. Examples of images processed in this way are shown in FIG. 30 (hue), FIG. 31 (saturation) and FIG. 32 (brightness), where large-scale images of a bee's body with varroa mites are presented. The grid indicates the image pixels. Method to detect parasites according to this invention is used, where areas of high brightness, created by the reflections of the light source, were detected in the HSB color space, selecting pixels whose B value was considerably larger than the B value of other pixels in the image, over 90% for example, and S value was not larger than 20%. Areas of said color values are indicated in FIG. 30-FIG. 32 as 80. When searching for regions with at least eight adjacent pixels, where the values of all the pixels are: B>90%, H>40° and S<20%, we get the area 81 on the FIGS. 30-32, with size of 17 pixels. The second step is to analyze pixels in an area of 16×16 pixels, a square which has its center at the center of area 81. For further proceeding, in this square at least 15% of the pixels must have parameters that match the criterion: H<30°, S<30%, B>60%. The pixels that match the criterion are circumscribed in the illustrations by contour 83, and there are a total of 47 pixels. Their proportion (percentage) is 19.7 (100×47/(256−17)=19.7%). The third step is to check a circular area of radius 27 pixels, circumscribed in the illustration by dashed line 86. There are three regions of pixels each surrounded by contour 85 which matched the criterion: H<15°, S>50%, B<80%, 31 pixels in total.

The counting results of the third step form the rating. If this is smaller than 15, the result is negative. The following table indicates the probability of there being a mite in the given reflection, based on the results of the third step.

| Sum | Probability of the presence of a mite |
|---|---|
| <15 | 0% |
| 15-19 | 10% |
| 20-50 | 50% |
| >50 | 80% |

### Example 8

### The Second Embodiment of the Method

The second embodiment of method uses the RGB color system. It uses a three-dimensional table, where the color regions considered to be close to those of reflected light of the light source are marked. In the image to be analyzed, pixels whose RGB values belong to the marked region are selected and circumscribed by squares of side length 50 pixels. Each pixel in the squares is rated by its RGB value, based on the rating from the said three dimensional ratings table. Ratings of each pixel in the square are added together and the sum is used to determine the probability of there being a mite in the area. The following scale is used:

| Sum | Probability of the presence of a mite |
|---|---|
| <100 | 0% |
| 100-199 | 10% |
| 200-499 | 50% |
| >500 | 80% |

The above described device and method embodiments use software embedded in the image processor memory, which contain parts of software code with the described above modules.

### INDUSTRIAL APPLICABILITY

The described device, in all six of its embodiment, can be produced industrially, to determine the number of varroa mites in a bee colony and decide on the need of control, or perform an effective control. The device, in its first, fifth or sixth embodiment should be used when preparing for wintering, or for treating colonies during winter, in which case the bees would have to be taken into a warmer room, temporarily interrupting the wintering. One device should be capable of selecting infected bees from the colony within one day (24 hours) and enough devices should be produced to allow companies offering varroatosis control services to use it. The device in its second, third and fourth embodiment should be used with colonies, completely treated from infection, living in regions where the risk of infection is high, to keep them safe. Various modification of this device could also be used in scientific research in the field of beekeeping.

1. A device for diagnose or control varroatosis, which comprises one or more cameras, which are connected to one or more image processors, comprising software, whose function is to recognize the image of a bee and by applying image processing to the image of the bee and/or by presenting images acquired from different orientation in relation to the bee to an operator for the operator's assistance, to determine the presence or absence of varroa mite on the body of one or more bees in view of cameras and according to that carry out one or more of the following actions:
a) count the number of infected and non-infected bees,
b) separate infected bees from the non-infected bees,
c) kill the detected mite,
whereas, to carry out action b) or/and c), the device is equipped with actuators, which are connected to the said one or more image processors.

2. The device according to claim 1, characterized in that it comprises at least one light source, which can be controlled by the said image processors and is capable of generating light impulses of length between 1 microsecond and 0.2 seconds.

3. The device according to claim 1, characterized in that the cameras for the observation of bees are placed above the landing board and/or below the transparent landing board.

4. The device according to claim 3, characterized in that further comprises one or more nozzles which are placed above the landing platform, in order to separate infected bees using an air stream to suck in the bees into nozzle(s), whereas an electromagnet impulse pump can be used to generate the said air stream.

5. The device for diagnosing or controlling varroatosis in bees, which comprises at least one camera, which is connected to one or more image processors, the function of which is to detect varroa mite, at least one light source, which is preferably to be controlled by said image processor and is capable of illuminating a bee with light impulses of length between 1 microsecond and 0.2 seconds, and at least one observation chamber, that preferably is equipped with at least one actuator, controlled by the image processor, to govern the movement of bees, which may be:
a) a gate, with which the image processor can inhibit or allow the entrance to or exit from the observation chamber,
b) a light source, with which to lure bees,
c) a valve or pump, with which to control the flow of air or narcotic gases into or out of the observation chamber.

6. The device according to claim 5, characterized in that at least one image processor comprises software, whose function is to determine, on an acquired image by applying image processing to said image and/or by presenting images acquired with different orientation in relation to the bee to an operator, the presence or absence of a varroa mite on the body of one or more bees in view of cameras and according to that carry out one or more of the following actions:
a) count the number of infected bees and the total number of bees,
b) separate infected bees from the non-infected bees,
c) kill the detected mite;
whereas to carry out action b) and/or c), the device is equipped with actuators, which are connected to the said one or more image processors.

7. The device according to claim 1, claim 2 or claim 5, characterized in that the image processing software comprises a module, the function of which is to detect a varroa mite in one or multiple images taken of the same bee using the following algorithm:
A) the image is searched for pixels corresponding to the characteristics of a varroa mite, that may be one or several adjacent pixels, which have a similar color to the reflection of the light source from the glossy body of the mite or similar color to the mite color;
B) said pixels are assigned one or more surrounding regions, of various sizes;
C) color value of pixels in each assigned surrounding regions are analyzed and according to presence of pixels having characteristic color, every surrounding region is given a region rating that indicate the probability of presence of the varroa mite in this area of the image;
D) based on said region(s) rating(s) and/or based on region ratings from different images a combined rating is composed, based on that it is determined, whether the bee is or is not infected by a varroa mite.

8. The device according to claim 1 or claim 5, characterized in that the said software comprises a module, whose function is to determine the location of various zones of the bee's body in different images of the same bee, and a module, whose function is to compose the combined rating, based on the region ratings of same body zone on different images or counting different body zones shown up in the images and to make decision about presence or absence of varroa mite, based on the said combined rating and the said counting result.

9. A device according to claim 1 or claim 5, characterized in that the software, which processes the images of bees, comprises a module, whose function is to determine the position of various body zones of the bee's body in the image and a module, whose function is to adjust the criteria(s) for detecting varroa mite depending on body zone, excluding the possibility of detection of the mite in certain zones of the bee's body.

10. A device according to claim 1, claim 5 or claim 7, characterized in that the image processing software contains a module, whose function is to adjust, according to detected images, the values of one or a few parameters that are used in the image processing.

11. The device according to claim 1 or claim 5, characterized in that a step or other means is placed in the field of view of the said camera(s), over which a bee must climb, making it easier the detection of varroa mite that occurs between the bee's thorax and abdomen.

12. The device according to claim 1 or claim 6 characterized in that the said actuator is a heat source, which may be implemented as a source of collimated radiation that can be directed by the image processor to the position of the mite.

13. The device according to claim 1 or claim 5 characterized in that the said cameras and/or further comprising one or several mirrors are positioned so as to acquire images of a bee from at least 3 different angles and preferably, the view angles between the cameras and/or mirrors are close to 360 degrees divided by number of view directions.

14. The device according to claim 5, characterized in that the size of the said observation chamber(s), is (are) large enough to allow a bee to turn around and/or stretch its wings away from its abdomen.

15. A method for detecting the presence and position of a parasite, for example, a varroa mite, on the body of a host, by image processing, which comprises the following steps:
A) the image of the host is searched for pixels whose color corresponding to the characteristics for the reflected light of the light source that may be one or several adjacent pixels, which have a similar color value to reflection of light from the glossy the body of the parasite;
B) one or a few different size surrounding regions are assigned to the said pixels;
C) color values of pixels in each assigned surrounding regions are analyzed and according to presence of pixels having characteristic color, each surrounding region is assigned a region rating, indicating the probability that there is a parasite in the determined area of the body of the host;
D) based on the said region ratings, it is determined, whether the given host is or is not infected by a parasite.

16. The method according to claim 15, characterized in that for higher efficacy of image processing, two or multiple images of the host are acquired and combined rating of presence or absence of parasite on the host is made up based on ratings of all the taken pictures.

17. The method according to claim 16, characterized in that when the said combined rating is generated, the positions of the host's body parts in the image and locations of the detected reflections in the host body are taken into account.

18. The method of determination of location of body elements in an image of an insect comprising the following steps:
A) separating the image of the insect image background and thresholding the said image to binary image;
B) eroding the insect blob by number of pixels enough to remove legs;
C) dilating result of eroding by about the same number of pixels or preferably by slightly higher amount of pixels;
D) subtracting result of dilation from initial binary image; whereas the result of dilation obtained in step C) is considered as body core and result of subtraction in step D) is considered as legs.

19. The method according to claim 18, characterized in that from said legs as determined antennas are selected as legs whose quotient of area to border length is less than certain criteria.

20. The method according to claim 19, characterized it that head of the insect is considered to be in this side of body where antennas are determined or which is closer to center of gravity of all legs.

21. A software (computer program product) stored in image processor memory of the device, and which comprises software code portions (modules), adapted to application of the device of claims 1-14 and to perform the method of claims 15-20, when the computer program is running in the processor.
